(19) United States
(12) Patent Application Publication
(10) Pub. No.: US 2026/0169575 A1
(43) Pub. Date: Jun. 18, 2026

(54) SENSOR DEVICE

(71) Applicant: ALPS ALPINE CO., LTD., Tokyo (JP)

(72) Inventors: Kazuhito OSHITA, Miyagi (JP); Takeshi MASAKI, Miyagi (JP)

(21) Appl. No.: 19/536,674

(22) Filed: Feb. 11, 2026

Related U.S. Application Data
(63) Continuation of application No. PCT/JP2024/008082, filed on Mar. 4, 2024.

(30) Foreign Application Priority Data
Aug. 31, 2023 (JP) 2023-141804

(51) Int. Cl. G06F 3/0346; B62D 1/06; G06F 3/01; G06F 3/041; G06F 3/044; G06F 3/04883

(52) U.S. Cl. CPC G06F 3/0346; B62D 1/06; G06F 3/017; G06F 3/0412; G06F 3/04184; G06F 3/044; G06F 3/0443; G06F 3/0445; G06F 3/0446; G06F 3/04883; G06F 2203/04808

(57) ABSTRACT

A sensor device includes a first proximity sensor outputting a first sensor value that varies according to a degree of proximity of a target object and provided inside one of a hub or a spoke of a steering operation unit, the first proximity sensor being disposed along a first lateral portion of a lateral surface of the one of the hub or the spoke, the lateral surface connecting a first outer surface on a driver side and a second outer surface opposite the first outer surface, a second proximity sensor to output a second sensor value that varies according to a degree of proximity of the target object provided inside the one of the hub or the spoke, the second proximity sensor being disposed along a second lateral portion of the lateral surface, and a processor to determine whether the target object is in contact with a grip.

### CROSS-REFERENCE TO RELATED APPLICATION

This application is a continuation application of International Application No. PCT/JP2024/008082, filed on Mar. 4, 2024, and designated the U.S., which is based upon and claims priority to Japanese Patent Application No. 2023-141804, filed on Aug. 31, 2023, the entire contents of which are incorporated herein by reference.

### TECHNICAL FIELD

The disclosures herein relate to sensor devices.

### BACKGROUND ART

A capacitive sensor device built into a steering wheel is known. The steering wheel has a rim and spokes connected to the inside of the rim, and the sensor device includes an electrode capable of capacitively coupling with an object to be detected, and a control part, and is provided on the spokes. The control unit detects a change in the capacitance of the electrode generated when the object approaches the rim or spoke, and determines whether or not the object (hand) approaches the rim or spoke based on the change in the capacitance (e.g., see Patent Literature (PTL) 1).

Note that even when a driver does not hold the rim (grip) of the steering wheel (steering operation unit), the electrostatic capacitance may change, for example, when a hand is present near the rim (grip), and there remains a scope for further improvement.

The present disclosure aims to provide a sensor device capable of accurately detecting whether a steering operation unit is being held.

### CITATION LIST

### Patent Literature

[PTL 1] International Publication Pamphlet No. WO 2020/195620

### SUMMARY OF THE INVENTION

A sensor device includes a first proximity sensor configured to output a first sensor value that varies according to a degree of proximity of a target object and provided inside one of a hub or a spoke of a steering operation unit including the hub, the spoke, and a grip, the first proximity sensor being disposed along a first lateral portion of a lateral surface of the one of the hub or the spoke, the lateral surface connecting a first outer surface on a driver side and a second outer surface opposite the first outer surface, and the first lateral portion being located closer to the first outer surface than to the second outer surface, a second proximity sensor configured to output a second sensor value that varies according to a degree of proximity of the target object and provided inside the one of the hub or the spoke, the second proximity sensor being disposed along a second lateral portion of the lateral surface, and the second lateral portion being located closer to the second outer surface than to the first outer surface, and a processor configured to determine at least one of that the target object is in contact with the grip when the first sensor value and the second sensor value are equal to or greater than a threshold value and are values indicating that an arrangement of the target object relative to the first proximity sensor and an arrangement of the target object relative to the second proximity sensor are regarded as an equivalent positional relationship, or an amount of change in the first sensor value and an amount of change in the second sensor value are equal to or greater than a threshold value and are values indicating that an arrangement of the target object relative to the first proximity sensor and an arrangement of the target object relative to the second proximity sensor are regarded as an equivalent positional relationship, or that the target object is not in contact with the grip when the first sensor value and the second sensor value are values indicating that an arrangement of the target object relative to the first proximity sensor and an arrangement of the target object relative to the second proximity sensor are regarded as different positional relationships, or an amount of change in the first sensor value and an amount of change in the second sensor value are values indicating that an arrangement of the target object relative to the first proximity sensor and an arrangement of the target object relative to the second proximity sensor are regarded as different positional relationships.

It is possible to provide a sensor device capable of accurately detecting whether a steering operation unit is being held.

### BRIEF DESCRIPTION OF THE DRAWINGS

FIG. 1 is a drawing illustrating an example of a configuration of a steering wheel mounted with a sensor device of an embodiment;

FIG. 2 is a drawing illustrating an example of a configuration of the sensor device of the embodiment;

FIG. 3A is a drawing illustrating an example of a specific configuration of an electrostatic sensor of the sensor device of the embodiment;

FIG. 3B is a drawing illustrating an example of the specific configuration of the electrostatic sensor of the sensor device of the embodiment;

FIG. 4A is a flowchart illustrating an example of a process executed by a determination unit;

FIG. 4B is a flowchart illustrating an example of a process for updating a reference value by a determination unit;

FIG. 4C is a flowchart illustrating an example of a hold determination process;

FIG. 4D is a flowchart showing an example of a non-hold determination process;

FIG. 5A is a drawing illustrating an example of a positional relationship between a driver's leg and a steering wheel;

FIG. 5B is a drawing illustrating an example of a distribution of difference values ΔAD of five electrostatic sensors; and

FIG. 5C is a flowchart illustrating an example of a determination process for distinguishing the driver's hand from the driver's leg.

### DESCRIPTION OF THE PREFERRED EMBODIMENT

In the following, an embodiment of the present disclosure to which a sensor device is applied will be described.

### Embodiment

In the following, an XYZ coordinate system will be defined and described. A direction parallel to an X-axis (X-direction), a direction parallel to a Y-axis (Y-direction), and a direction parallel to a Z-axis (Z-direction) are orthogonal to each other. The term plane view refers to an XY-plane view. In the following, the length, thickness, and the like of each part may be exaggerated to facilitate understanding of the structure.

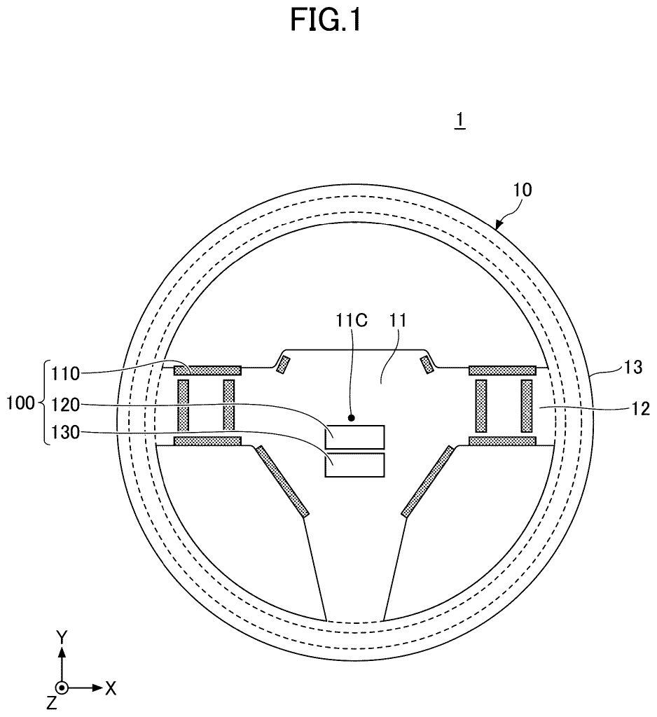

FIG. 1 is a drawing illustrating an example of a configuration of a steering wheel 10 mounted with a sensor device 100 of the embodiment. The steering wheel 10 is an example of a steering operation unit. The sensor device 100 and the steering wheel 10 are included in a steering wheel unit 1.

Hereinafter, unless otherwise specified, the configuration of the steering wheel 10 as seen from a driver's seat when it is mounted on a vehicle and in a neutral state will be described. The XY-plane is a plane normal to an axial direction of a steering shaft of the vehicle (not shown), the steering shaft being connected to a hub 11 of the steering wheel 10. That is, the Z-direction is an extending direction of the steering shaft of the vehicle (not shown) connected to the hub 11 of the steering wheel 10. The driver's seat and the driver are positioned in the +Z-direction of the steering wheel 10.

The +X direction corresponds to the right side and the −X direction corresponds to the left side, as viewed from the driver of the vehicle on which the steering wheel 10 is mounted. Therefore, the +X-direction may be referred to as right, and the −X-direction may be referred to as left. When the steering wheel 10 is described, the +Y-direction may be referred to as top, and the −Y-direction may be referred to as bottom.

The sensor device 100 performs a determination process described later to detect that the driver's hand is in contact with a rim 13 of the steering wheel 10. The fact that the driver's hand is in contact with the rim 13 is equivalent to the fact that the driver is holding the rim 13 with the hand. In the following description, it is assumed that the object detected by the sensor device 100 is the driver's hand.

### <Steering Wheel 10>

The steering wheel 10 has the hub 11, spokes 12, and the rim 13. The rim 13 is an example of a grip of a steering wheel. The hub 11 is connected to the steering shaft of the vehicle (not shown). The hub 11 has a center 11C which is a center of rotation accompanying rotation of the steering shaft. The center 11C may be offset from the center of the rim 13 in plan view.

Three spokes 12 are connected to the hub 11 in the +X-direction, the −X-direction, and the −Y-direction. The inner periphery of the rim 13 is connected to the three spokes 12. The surfaces of the hub 11 and the spokes 12 are covered with a decorative member made of resin or the like.

Although FIG. 1 shows three spokes 12 extending radially outward of the rim 13 from the hub 11 at the center of the steering wheel 10, the number of spokes 12 may be any number. The rim 13 does not have to be annular or circular, and may have various shapes, such as a rectangular shape or a D-shape.

The steering wheel 10 has a core metal made of a metal material such as iron. The core metal has the same shape as the steering wheel 10 in plan view, and has portions corresponding to the hub 11, the spokes 12, and the rim 13.

The hub 11 and the spoke 12 are made by attaching a resin member, a decorative member, or the like to the hub and the spoke of the core metal. The rim 13 is made by attaching a urethane foam or a skin to the rim of the core metal. The skin of the rim 13 is a portion in direct contact with the hand of the driver of the vehicle. As an example, the skin is made of genuine leather, artificial leather, resin, or the like.

### <Sensor Device 100>

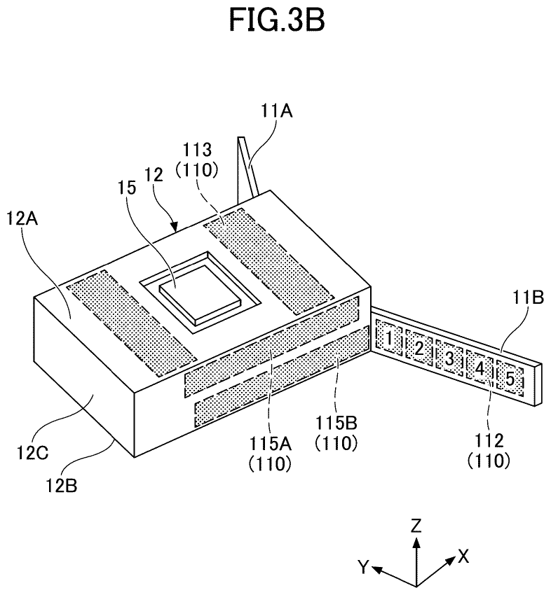

The sensor device 100 includes an electrostatic sensor 110, a detection circuit 120, and an ECU (Electronic Control Unit) 130. The electrostatic sensor 110 is an example of a proximity sensor. The sensor device 100 includes a plurality of electrostatic sensors 110. FIG. 1 schematically shows positions of the plurality of electrostatic sensors 110, and specific arrangements and the like will be described later with reference to FIGS. 3A and 3B.

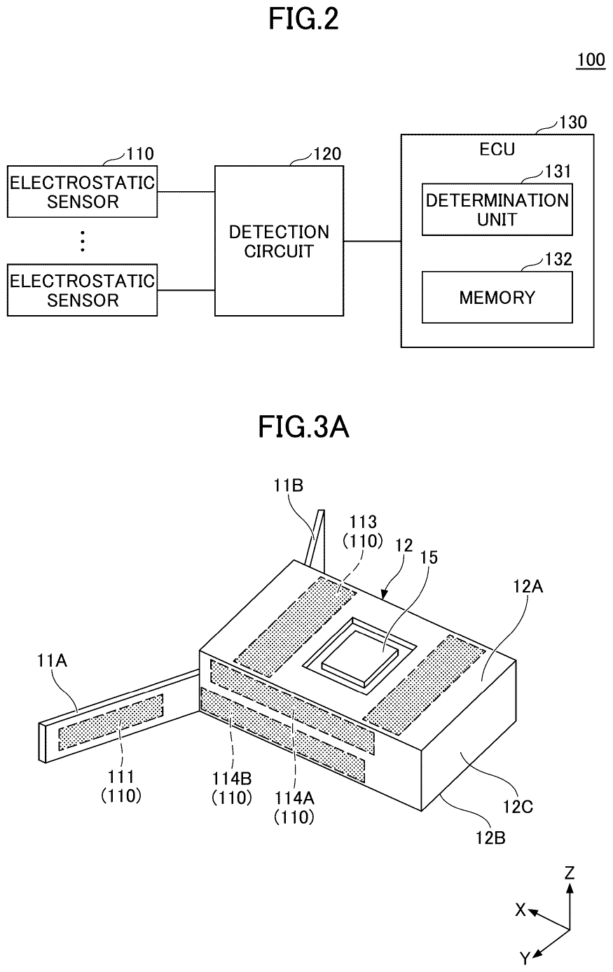

The ECU 130 is, for example, an HODECU (Hands Off Detection Electronic Control Unit). The sensor device 100 will be described with reference to FIG. 2 in addition to FIG. 1. FIG. 2 is a drawing illustrating an example of a configuration of the sensor device 100 of the embodiment.

FIG. 1 shows the electrostatic sensor 110, the detection circuit 120, and the ECU 130 in a simplified manner, but actually, as shown in FIG. 2, the electrostatic sensor 110 is connected to the detection circuit 120, and the detection circuit 120 is connected to the ECU 130. Further, the electrostatic sensor 110, the detection circuit 120, and the ECU 130 are not actually exposed to the surface of the steering wheel 10, and are provided, for example, inside the hub 11 and the spokes 12, but are shown transparently in FIG. 1.

The electrostatic sensor 110 is an electrode formed of a conductor, and is provided for detecting whether or not the driver's hand is in contact with the rim 13. As the electrode included in the electrostatic sensor 110, for example, a deformable substrate material such as a resin film coated with silver paste, or an electrode formed of a deformable substrate material such as a resin film coated with aluminum foil, copper foil, or the like, can be used.

The electrostatic sensor 110 is provided inside the hub 11 and the spokes 12 of the steering wheel 10 as an example, and is covered with decorative members of the hub 11 and the spokes 12. The electrostatic sensor 110 is not provided on the rim 13. The electrostatic sensor 110 is connected to the detection circuit 120.

Instead of the electrostatic sensor 110 as an example of a proximity sensor, a reflective photoreflector including a light-emitting element and a light-receiving element may be used to detect whether the driver's hand is in contact with the rim 13 by emitting light from the light-emitting element and receiving light reflected by the driver's hand. In addition, instead of the electrostatic sensor 110 as an example of a proximity sensor, a millimeter-wave radar or an ultrasonic sonar may be used to detect whether the driver's hand is in contact with the rim 13 by detecting reflected waves of radar or ultrasonic waves.

Like the electrostatic sensor 110, the reflective photoreflector, the millimeter-wave radar or the ultrasonic sonar may be provided inside the hub 11 and the spokes 12, and may be covered by the decorative members of the hub 11 and the spokes 12. The decorative member may be provided with an opening corresponding to a transmitting and receiving unit through which the reflective photoreflector, the millimeter-wave radar or the ultrasonic sonar transmits and receives light, radar or millimeter-wave, and the light, radar or millimeter-wave may pass through the opening. The reflective photoreflector, the millimeter-wave radar or the ultrasonic sonar may be provided inside the hub 11 and the spokes 12, which means that a main body portion other than the transmitting and receiving unit of the reflective photoreflector, the millimeter-wave radar or the ultrasonic sonar is provided inside the hub 11 and the spokes 12, and a part or the entirety of the transmitting and receiving unit is exposed to the outside of the decorative member.

As an example, the detection circuit 120 and the ECU 130 may be provided inside the hub 11 and covered by the decorative member of the hub 11. However, the detection circuit 120 and the ECU 130 may be provided inside the hub 11 and the spokes 12 and covered by the decorative member of the hub 11 and the spokes 12. Further, the detection circuit 120 may be provided inside the hub 11 and the ECU 130 may be provided inside the spokes 12. The detection circuit 120 may be provided inside the spokes 12, and the ECU 130 may be provided inside the hub 11. The detection circuit 120 and the ECU 130 may be provided outside the steering wheel 10.

The detection circuit 120 is connected to a plurality of electrostatic sensors 110, and detects the capacitance of each electrostatic sensor 110. The detection circuit 120 digitally converts the capacitance of the electrostatic sensors 110 to obtain a value AD corresponding to the capacitance of each electrostatic sensor 110, and outputs the value AD to the ECU 130.

The ECU 130 has a determination unit 131 and a memory 132. The ECU 130 is achieved by a computer including a CPU (Central Processing Unit), a RAM (Random Access Memory), a ROM (Read Only Memory), an input and output interface, an internal bus, and the like. The determination unit 131 indicates a function of a program executed by the ECU 130 as a function block. The memory 132 functionally indicates a memory of the ECU 130.

The ECU 130 is connected to the detection circuit 120. The determination unit 131 updates a reference value corresponding to a noise floor. Then, the reference value is subtracted from the value AD corresponding to the electrostatic capacitance to obtain a difference value ΔAD, and based on the difference value ΔAD, it is determined whether the driver's hand is in contact with the rim 13. The memory 132 stores a reference value of each electrostatic sensor, and a program and data used by the determination unit 131 to execute a process for determining whether the driver's hand is in contact with the rim 13.

The ECU 130 is connected, for example, to a vehicle-mounted higher-level device such as an ADAS ECU (Advanced Driver-Assistance System Electronic Control Unit). The ADAS ECU is a device for controlling a system for supporting advanced driving such as an automatic driving system. The automatic driving system may be a level 3 or higher of the automatic driving level 0 to 5 specified by the Society of Automotive Engineers of Japan, Inc. (JSAE).

In the present embodiment, the capacitance of the electrostatic sensor 110 is digitally converted by the detection circuit 120, but may be converted by the ECU 130. Further, the update of the reference value and the calculation of the difference value ΔAD performed by the ECU 130 may be performed by the detection circuit 120.

The sensor device 100 as described above detects that the driver's hand is in contact with the rim 13 based on the capacitance of the electrostatic sensor 110 provided inside the hub 11 and the spokes 12 of the steering wheel 10. A specific configuration of the electrostatic sensor 110 and a specific determination process performed by the determination unit 131 will be described below.

### <Specific Configuration of Electrostatic Sensor 110, Hub 11, and Spoke 12>

FIGS. 3A and 3B are drawings illustrating an example of the specific configuration of the electrostatic sensor 110. FIGS. 3A and 3B show hub panels 11A and 11B, provided on the lateral surface of the hub 11, and the spoke 12 in addition to the electrostatic sensor 110. What is shown as the spoke 12 in FIGS. 3A and 3B is a portion of a resin member and a decorative member excluding a core metal, and is a spoke 12 located on the left of the hub 11 among the three spokes 12.

Here, although the spoke 12 located on the left of the hub 11 will be described, the spoke 12 located on the right of the hub 11 among the three spokes 12 has a configuration symmetrical with the left spoke 12 shown in FIGS. 3A and 3B.

The lateral surface of the hub 11 is a lateral surface connecting an outer surface in the +Z-direction and an outer surface in the −Z-direction of the hub 11. The outer surface in the +Z-direction of the hub 11 is an outer surface on the driver side and is an example of a first outer surface. The outer surface in the −Z-direction of the hub 11 is an outer surface opposite to the outer surface in the +Z-direction and is an example of a second outer surface.

The hub panels 11A and 11B and the spoke 12 are seamlessly formed of a resin. The hub panel 11A is a portion of the lateral surface of the hub 11 of the steering wheel 10 that is located above the left spoke 12 and extends along an outer edge of the hub 11 in plan view. The hub panel 11B is a portion of the lateral surface of the hub 11 of the steering wheel 10 that is located below the left spoke 12 and extends along the outer edge of the hub 11 in plan view.

The spoke 12 has an outer surface 12A in the +Z-direction, an outer surface 12B in the −Z-direction, and a lateral surface 12C. In FIGS. 3A and 3B, the outer surface 12B opposite the outer surface 12A is not visible, but the position of the edge of the outer surface 12B is indicated by the reference numeral.

The lateral surface 12C is a lateral surface connecting the outer surfaces 12A and 12B, and is a lateral surface of the generally rectangular parallelepiped spoke 12 in the +Y-direction, the −Y-direction, the +X-direction, and the −X-direction. The outer surface 12A of the spoke 12 in the +Z-direction is a driver side surface and is an example of the first outer surface. The outer surface 12B of the spoke 12 in the −Z-direction is an outer surface opposite in the +Z-direction and is an example of the second outer surface. As an example, a switch 15 is provided on the outer surface 12A of the spoke 12. The switch 15 is an input unit for operating an electronic device or the like of the vehicle to which the steering wheel 10 is mounted. As an example, the switch 15 is a switch capable of operating an audio device or a telephone.

In the present embodiment, the hub panels 11A and 11B and the spoke 12 are provided with the electrostatic sensors 110, and the spoke 12 is provided with the switch 15. However, the housing of the switch and the hub panel may be seamlessly formed as a part of the spoke, and the electrostatic sensors may be provided in the hub panels and the spoke and incorporated into a storage part provided in the spoke.

The hub panels 11A and 11B and the spoke 12 are provided with the electrostatic sensors 111, 112, 113, 114A, 114B, 115A, and 115B. The electrostatic sensors 111 to 115B are specific configurations of the electrostatic sensors 110 shown in FIGS. 1 and 2. Hereinafter, when the electrostatic sensors 111 to 115B are not particularly distinguished, the term electrostatic sensor 110 is used.

### <Electrostatic Sensor 111>

As an example, the electrostatic sensor 111 is provided inside the hub panel 11A along the surface of the hub panel 11A (lateral surface of the hub 11). That is, the electrostatic sensor 111 is provided inside the hub panel 11A directly behind the surface of the hub panel 11A (lateral surface of the hub 11). Since the hub panel 11A is a part of the hub 11, the electrostatic sensor 111 is provided inside the hub 11 directly behind the lateral surface of the hub 11. As an example, the electrostatic sensor 111 is a substantially rectangular electrode having a longitudinal direction extending along the outer edge of the hub 11 in plan view. Although the electrostatic sensor 111 is rectangular in the present embodiment, a trapezoidal shape or other shape may be used.

The electrostatic sensor 111 is used in a determination process to distinguish between the driver inserting a hand between the right and left spokes 12 and the rim 13 to operate a switch or the like in a meter panel, and the driver touching the rim 13. The determination process will be described later.

### <Electrostatic Sensor 112>

As an example, five electrostatic sensors 112 are provided inside the hub panel 11B along the surface of the hub panel 11B (lateral surface of the hub 11). That is, the five electrostatic sensors 112 are provided inside the hub panel 11B directly behind the surface of the hub panel 11B (lateral surface of the hub 11). That is, they are disposed along the lateral surface connecting the driver side surface of the hub 11 or the spoke 12 and the surface opposite the driver side surface. They may be disposed along the lateral surface connecting the driver side surface and the surface opposite the spoke 12. As an example, the areas of the five electrostatic sensors 112 are equal to each other, and each electrostatic sensor 112 is a rectangular electrode. Since the hub panel 11B is disposed on the floor side (lower part) of the vehicle body relative to the center 11C of the hub 11, the five electrostatic sensors 112 are disposed on the floor side of the vehicle body relative to the center 11C of the hub 11.

Here, the five electrostatic sensors 112 are sequentially numbered first to fifth to be distinguished. The first electrostatic sensor 112 is closest to the left spoke 12 and is positioned on the uppermost side among the five electrostatic sensors 112. The fifth electrostatic sensor 112 is farthest from the left spoke 12 and is positioned on the lowermost side among the five electrostatic sensors 112.

The five electrostatic sensors 112 are used for a determination process to distinguish between the driver's hand and the driver's leg. The determination process will be described later.

### <Electrostatic Sensor 113>

As an example, two electrostatic sensors 113 are provided inside the spoke 12 along the outer surface 12A. That is, two electrostatic sensors 113 are provided inside the spoke 12 directly behind the outer surface 12A. As an example, the two electrostatic sensors 113 are rectangular electrodes long in the Y-direction in plan view, and are provided on the +X-direction and the −X-direction of the switch 15 as an example. As an example, the two electrostatic sensors 113 have the same area.

The electrostatic sensor 113 is used in a determination process to distinguish between a case in which a hand is positioned on a +Z-direction side of the rim 13 and a case in which the hand is in contact with the rim 13. The determination process will be described later.

In addition to the outer surface 12A or in place of the outer surface 12A, the electrostatic sensor 113 may be provided inside the spoke 12 along the outer surface 12B. That is, the electrostatic sensor 113 may be provided inside the spoke 12 directly behind the outer surface 12B. For example, when a switch or the like is provided on the outer surface 12B on the −Z-direction of the spoke 12, or when a lever or the like is provided on the −Z-direction of the spoke 12, the electrostatic sensor 113 may be provided inside the spoke 12 along the outer surface 12B in order to distinguish the operation from touching the rim 13 by hand.

### <Electrostatic Sensors 114A and 114B and Electrostatic Sensors 115A and 115B>

As an example, the electrostatic sensor 114A is provided inside the spoke 12 along a portion on the lateral surface 12C of the spoke 12 on the +Y-direction side and on the +Z-direction side. As an example, the electrostatic sensor 114B is provided inside the spoke 12 along a portion on the lateral surface 12C of the spoke 12 on the +Y-direction side and on the −Z-direction side. As an example, the electrostatic sensors 114A and 114B are rectangular electrodes and have equal areas (sizes in XZ plan view).

As an example, the electrostatic sensor 115A is provided inside the spoke 12 along a portion on the lateral surface 12C of the spoke 12 on the −Y-direction side and on the +Z-direction side. As an example, the electrostatic sensor 115B is provided inside the spoke 12 along a portion on the lateral surface 12C of the spoke 12 on the −Y-direction side and on the −Z-direction side. As an example, the electrostatic sensors 115A and 115B are rectangular electrodes and have equal areas (sizes in XZ plan view).

The portion on the lateral surface 12C of the spoke 12 on the +Y-direction side and on the +Z-direction side and the portion on the lateral surface 12C of the spoke 12 on the −Y-direction side and on the +Z-direction side are examples of first lateral portions of the lateral surface 12C on the +Y-direction side and the −Y-direction side that are close to the outer surface 12A. For example, the portion on the lateral surface 12C of the spoke 12 on the +Y-direction side and on the +Z-direction side is approximately half of a portion on the lateral surface 12C on the +Y-direction side and on the +Z-direction side (driver side). The portion on the lateral surface 12C of the spoke 12 on the −Y-direction side and on the +Z-direction side is approximately half of a portion on the lateral surface 12C on the −Y-direction side and on the +Z-direction side (driver side).

The portion on the lateral surface 12C of the spoke 12 on the +Y-direction side and on the −Z-direction side and the portion on the lateral surface 12C of the spoke 12 on the −Y-direction side and on the −Z-direction side are examples of second lateral portions of the lateral surface 12C on the +Y-direction side and the −Y-direction side that are close to the outer surface 12B. The portion on the lateral surface 12C of the spoke 12 on the +Y-direction side and on the −Z-direction side is approximately half of a portion on the lateral surface 12C on the +Y-direction side and on the −Z-direction side. The portion on the lateral surface 12C of the spoke 12 on the −Y-direction side and on the −Z-direction side is approximately half of a portion on the lateral surface 12C on the −Y-direction side and on the −Z-direction side.

The electrostatic sensors 114A, 114B, 115A, and 115B can be used in a determination process to distinguish between a case in which a hand is in contact with the outer surface 12A of the spoke 12 and a case in which the hand is in contact with the rim 13. The determination process will be described later.

### <Flowchart>

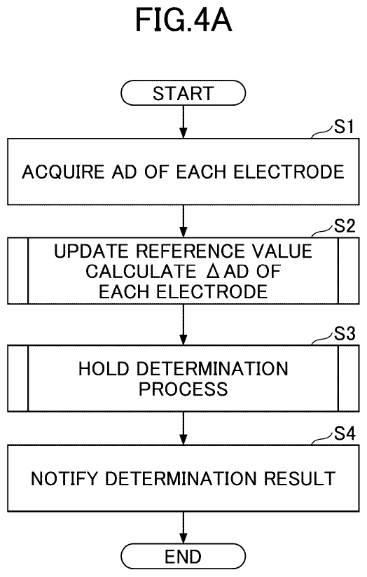

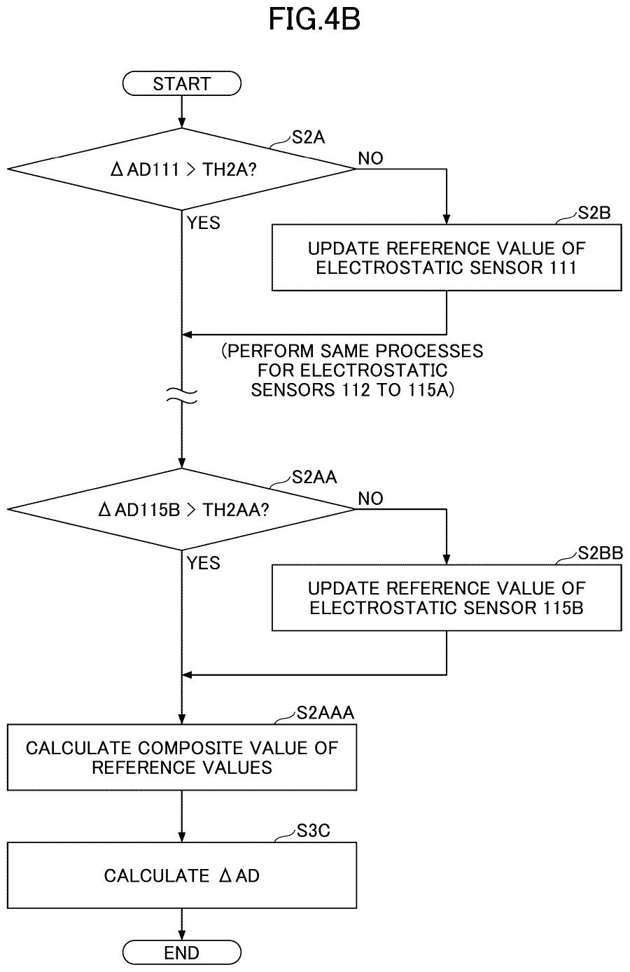

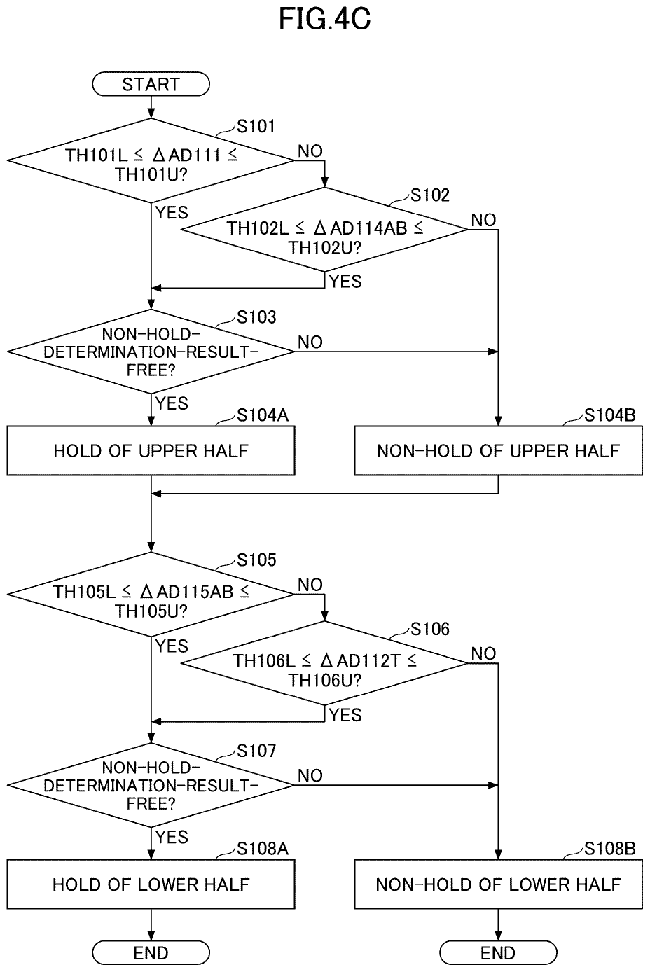

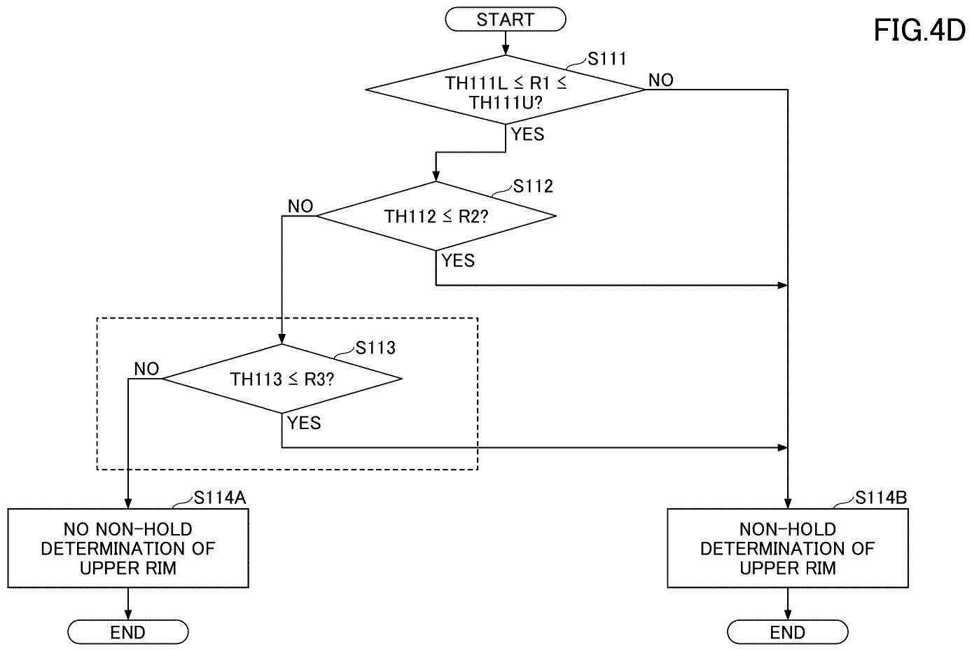

### <Overall Process: FIG. 4A>

FIG. 4A is a flowchart illustrating an example of a process executed by the determination unit 131.

Upon starting the process, the determination unit 131 acquires a value AD corresponding to the capacitance of each electrostatic sensor 110 from the detection circuit 120 (step S1).

The determination unit 131 updates a reference value corresponding to the noise floor to be used for calculating the difference value ΔAD. Then, the determination unit 131 obtains a difference value ΔAD obtained by subtracting the reference value from the value AD corresponding to the electrostatic capacitance (step S2). The process of step S2 is a subroutine process.

The determination unit 131 performs a hold determination process for determining whether or not the rim 13 of the steering wheel 10 is held (step S3). The process of step S3 is a subroutine process.

The determination unit 131 notifies a higher-level device of the determination result (step S4). The higher-level device is, for example, an ADAS ECU. Thus, a series of processes is completed.

### <Update of Reference Value and Calculation of Difference Value ΔAD: FIG. 4B>

FIG. 4B is a flowchart illustrating an example of a process for updating a reference value by the determination unit 131. The process shown in FIG. 4B is a subroutine process of step S2 of FIG. 4A.

The determination unit 131 determines whether the difference value ΔAD111 of the electrostatic sensor 111 is greater than the threshold value TH2A (step S2A). As an example, the threshold value TH2A is set to the electrostatic capacitance of the electrostatic sensor 111 in a state where the electrostatic capacitance of the electrostatic sensor 111 is slightly affected by a hand. By using such a threshold value TH2A, a measured AD value corresponding to the noise floor in a state where the electrostatic capacitance of the electrostatic sensor 111 is not affected by a hand can be acquired as a reference value. The electrostatic capacitance of the electrostatic sensor 111 varies depending on the environmental temperature of the sensor device 100. This is because, when the temperature changes, the dielectric constant or the like of the decorative member covering the electrostatic sensor 111 changes. In order to cope with such a variation in the electrostatic capacitance, the reference value is updated. The reference value of the electrostatic sensor 111 is stored in the memory 132, and is rewritten when updated. The same applies to another electrostatic sensor.

When the determination unit 131 determines that the difference value ΔAD111 for the electrostatic sensor 111 is not greater than the threshold value TH2A (S2A: NO), the reference value of the electrostatic sensor 111 is updated to the measured AD value of the electrostatic sensor 111 (step S2B). That is, when it is determined that the difference value ΔAD111 of the electrostatic sensor 111 is not greater than the threshold value TH2A (S2A: NO), it is determined that the hand is not close to the sensor, and the measured AD value at that time is regarded as a value corresponding to the noise floor, and is used as a new reference value.

When the determination unit 131 determines in step S2A that the difference value ΔAD111 for the electrostatic sensor 111 is greater than the threshold value TH2A (S2A: YES), the process proceeds by skipping step S2B. In this case, the reference value is not updated because the hand is close to the electrostatic sensor 111.

The determination unit 131 performs the same process as in steps S2A and S2B for the electrostatic sensors 112 to 115A. In the process for the electrostatic sensors 112 to 115A, the threshold values TH112 to TH115A set for each of the electrostatic sensors 112 to 115A may be used. Since the electrostatic sensors 112 to 115A have different environments, it is preferable to use appropriate thresholds for each of them.

For the two electrostatic sensors 113, the determination unit 131 may perform the updating process of the reference values separately using different thresholds for each of the electrostatic sensors 113. Similarly, for the five electrostatic sensors 112, the updating process of the reference values may be performed separately.

The determination unit 131 determines whether the difference value ΔAD115B for the electrostatic sensor 115B is greater than the threshold value TH2AA (step S2AA). As an example, the threshold value TH2AA is set to the capacitance of the electrostatic sensor 115B in a state where the capacitance of the electrostatic sensor 115B is slightly affected by a hand.

When the determination unit 131 determines that the difference value ΔAD115B of the electrostatic sensor 115B is not greater than the threshold value TH2AA (S2AA: NO), the determination unit updates the reference value of the electrostatic sensor 115B to the measured AD value of the electrostatic sensor 115B (step S2BB).

If the determination unit 131 determines that the difference value ΔAD115B of the electrostatic sensor 115B is greater than the threshold value TH2AA (S2AA: YES) in step S2AA, the determination unit skips step S2BB and proceeds with the process.

The determination unit 131 calculates a composite value of the reference values of the five electrostatic sensors 112, a composite value of the reference values of the two electrostatic sensors 113, a composite value of the reference values of the electrostatic sensors 114A and 114B, and a composite value of the reference values of the electrostatic sensors 115A and 115B (step S2AAA). Since the reference value is an electrostatic capacitance, the composite value of the reference value may be calculated as a sum of a plurality of reference values, similarly to the case where a composite value of electrostatic capacitance of parallel capacitors is obtained.

Thus, the process for updating the reference value by the determination unit 131 (see FIG. 4B) is completed.

Then, the determination unit 131 calculates ΔAD using the reference value stored in the memory 132 (step S3C).

### <Hold Determination Process: FIG. 4C>

FIG. 4C is a flowchart illustrating an example of a hold determination process. The process shown in FIG. 4C is a subroutine process of step S3 of FIG. 4A. The process shown in FIG. 4C is a process for determining whether the hand is in contact with an upper half or a lower half of the rim 13. The upper half of the rim 13 is approximately an upper half of an annular rim 13 in plan view, and is within a range detectable by the right and left electrostatic sensors 111 and the right and left electrostatic sensors 114A and 114B. The lower half of the rim 13 is approximately a lower half of the annular rim 13 in plan view, and is within a range detectable by the right and left electrostatic sensors 112 and the right and left electrostatic sensors 115A and 115B.

Here, the process for determining using the left electrostatic sensors 111, 112, 114A, 114B, 115A, and 115B will be described, but the same determination process may be performed for the right side. If it is determined that the hand is in contact with the rim 13 on at least either the left side or the right side, it means that the driver is holding the rim 13 by hand.

As described above, the electrostatic sensors 111 to 115B are covered with decorative members provided on the surfaces of the hub 11 or the spoke 12. Hereinafter, when the hand is in contact with the decorative member covering the electrostatic sensor 111, although the hand is actually in proximity to the electrostatic sensor 111, this state is referred to as a state in which the hand is in contact with the electrostatic sensor 111. The same applies to the electrostatic sensors 112 to 115B.

When the process is started, the determination unit 131 determines whether the difference value ΔAD111 of the electrostatic sensor 111 is equal to or greater than the threshold value TH101L and equal to or less than the threshold value TH101U (step S101). The process of step S101 determines whether the difference value ΔAD111 of the electrostatic sensor 111 is within the range from the threshold value TH101L to the threshold value TH101U.

Note that the threshold value TH101L may be set to a lower limit value capable of determining that the hand is in contact with the rim 13 based on the difference value ΔAD111. The threshold value TH101U may be set to an upper limit value capable of determining that the hand is in contact with the rim 13 based on the difference value ΔAD111. That is, when the hand is holding the rim 13, the distance between the electrostatic sensor 111 and the hand is within a predetermined range, and the measured difference value ΔAD111 is also within a predetermined range. In other words, if the measured difference value ΔAD111 is equal to or less than the threshold value TH101L, the distance between the electrostatic sensor 111 and the hand is equal to or greater than a predetermined distance, and there is no possibility that the hand is holding the rim 13. If the difference value ΔAD111 is equal to or greater than the threshold value TH101U, the distance between the electrostatic sensor 111 and the hand is equal to or less than the predetermined distance and the distance is excessively small, and there is no possibility that the hand is holding the rim 13 (NO in step S101). If the difference value ΔAD111 is equal to or greater than the threshold value TH101L and equal to or less than the threshold value TH101U, the distance between the electrostatic sensor 111 and the hand is within a predetermined range, and it is assumed that the hand is in contact with and holds the upper half of the rim, or the hand holds the rim 13 (YES in step S101), and the flow proceeds to the subsequent flow. The specific values of the threshold values TH101L and TH101U may be set to appropriate values based on simulation or actual measurement results in consideration of the positional relationship between the rim 13 and the electrostatic sensor 111, the area of the electrostatic sensor 111, and the dielectric constant, thickness, the stray capacitance, and the like of the decorative member or the like surrounding the electrostatic sensor 111.

If the determination unit 131 determines that the difference value ΔAD111 is equal to or greater than the threshold value TH101L and equal to or less than the threshold value TH101U (YES in step S101), the flow proceeds to step S103.

When the determination unit 131 determines that the difference value ΔAD111 is not less than the threshold value TH101L and not less than the threshold value TH101U (step S101: NO), it determines whether the composite value ΔAD114AB of the difference values ΔAD114A and Δ114B of the electrostatic sensors 114A and 114B is not less than the threshold value TH102L and not more than the threshold value TH102U (step S102).

Since the electrostatic sensors 114A and 114B are treated as capacitors connected in parallel, the composite value ΔAD114AB is the sum of the difference values ΔAD114A and Δ114B. The process of step S102 is a process of determining whether the composite value ΔAD114AB is within the range from the threshold value TH102L to the threshold value TH102U.

Note that the threshold value TH102L may be set to a lower limit value capable of determining that the hand is in contact with the rim 13 based on the composite value ΔAD114AB. The threshold value TH102U may be set to an upper limit value capable of determining that the hand is in contact with the rim 13 based on the composite value ΔAD114AB. That is, as in the case of the electrostatic sensor 111, if the composite value ΔAD114AB to be measured is equal to or less than the threshold value TH102L, the distance between the electrostatic sensor 114A or 114B and the hand is equal to or greater than a predetermined value, and there is no possibility that the hand is holding the rim 13. If the composite value ΔAD114AB is equal to or greater than the threshold value TH102U, the distance between the electrostatic sensor 114A or 114B and the hand is equal to or less than the predetermined distance and the distance is excessively small, and there is no possibility that the hand is holding the rim 13 (NO in step S102). If the composite value ΔAD114AB is equal to or greater than the threshold value TH102L and equal to or less than the threshold value TH102U, the distance between the electrostatic sensor 114A or 114B and the hand is within a predetermined range, and it is assumed that the hand is in contact with and holds the upper half of the rim, or the hand holds the rim 13 (YES in step S101), and the flow proceeds to the subsequent flow. The specific values of the threshold values TH102L and TH102U may be set to appropriate values based on simulation or actual measurement results in consideration of the positional relationship between the rim 13 and the electrostatic sensors 114A and 114B, the area of the electrostatic sensors 114A and 114B, and the dielectric constant, thickness, the stray capacitance, and the like of the decorative member or the like surrounding the electrostatic sensors 114A and 114B. When the distance between the electrostatic sensor 114A and the rim 13 is different from the distance between the electrostatic sensor 114B and the rim 13, the threshold value TH102L and the threshold value TH102U may be set to appropriate values in consideration of the difference in distances. This is because a long (far) distance substantially corresponds to a small electrode area. Note that the composite value ΔAD114AB was used for determination in step S102, but instead of this, ΔAD114A or ΔAD114B may be used for determination.

When the determination unit 131 determines that the difference value ΔAD111 is equal to or greater than the threshold value TH101L and equal to or less than the threshold value TH101U (step S101), or when the composite value ΔAD114AB is equal to or greater than the threshold value TH102L and equal to or less than the threshold value TH102U (step S102: YES), it determines whether or not it is free from the non-hold determination result (step S103). The non-hold determination result means that it is determined that the driver's hand is not in contact with the rim 13 (non-hold) by the non-hold determination process described later. Free from non-hold determination results means that there are no non-hold determination results.

Even when the sensor device 100 determines that the driver's hand is in contact with the rim 13 based on the difference values ΔAD111, ΔAD114A, and ΔAD114B of the electrostatic sensors 111, 114A, and 114B, respectively, it determines whether or not the driver is in a non-hold state by the non-hold determination process in step S103 in order to prevent erroneous determination. The same applies to the lower half of the rim 13.

When the determination unit 131 determines that the determination results are free from the non-hold determination result (S103: YES), the determination unit 131 maintains the determination made at YES in step S101 or YES in step S102, and determines that the hand is in contact with the upper half of the rim 13, where the hand is determined to be holding, or regarded as holding, the upper half of the rim 13 (step S104A).

If the determination unit 131 determines in step S103 that the determination results are not free from the non-hold determination results (S103: NO), it determines that the hand is not in contact with the upper half of the rim 13 (step S104B).

If the determination unit 131 determines in step S102 that the composite value ΔAD114AB is not less than the threshold value TH102L but not less than the threshold value TH102U (S102: NO), it determines that the hand is not in contact with the upper half of the rim 13 (non-hold) (step S104B).

When the determination unit 131 finishes the process in step S104A or step S104B, the flow proceeds to step S105. Since steps S105 to S108 are common to steps S101 to S108, detailed description thereof is omitted.

The determination unit 131 determines whether or not the composite value ΔAD115AB of the difference values ΔAD115A and Δ115B of the electrostatic sensors 115A and 115B, respectively, is equal to or greater than the threshold value TH105L and equal to or less than the threshold value TH105U (step S105).

Since the electrostatic sensors 115A and 115B are treated as capacitors connected in parallel, the composite value ΔAD115AB is the sum of the difference values ΔAD115A and Δ115B. The process in step S105 determines whether or not the composite value ΔAD115AB is within the range from the threshold value TH105L to the threshold value TH105U.

Note that the threshold value TH105L may be set to a lower limit value capable of determining that the hand is in contact with the rim 13 based on the composite value ΔAD115AB. The threshold value TH105U may be set to an upper limit value capable of determining that the hand is in contact with the rim 13 based on the composite value ΔAD115AB. The specific values of the threshold values TH105L and TH105U may be set to appropriate values based on simulation or actual measurement results in consideration of the positional relationship between the rim 13 and the electrostatic sensors 115A and 115B, the area of the electrostatic sensors 115A and 115B, and the dielectric constant, thickness, the stray capacitance, and the like of the decorative member or the like surrounding the electrostatic sensors 115A and 115B. When the distance between the electrostatic sensor 115A and the rim 13 is different from the distance between the electrostatic sensor 115B and the rim 13, the threshold value TH105L and the threshold value TH105U may be set to appropriate values in consideration of the difference in distances. This is because a long (far) distance substantially corresponds to a small electrode area.

If the determination unit 131 determines that the composite value ΔAD115AB is equal to or greater than the threshold value TH105L and equal to or less than the threshold value TH105U (S105: YES), the flow proceeds to step S107.

When it is determined that the composite value ΔAD115AB is equal to or greater than the threshold value TH105L and greater than the threshold value TH105U (NO at step S105), the determination unit 131 determines whether the composite value ΔAD112T of the difference values of the five electrostatic sensors 112 is equal to or greater than the threshold value TH106L and equal to or less than the threshold value TH106U (step S106).

Since the five electrostatic sensors 112 are treated as capacitors connected in parallel, the composite value ΔAD115T is the sum of the difference values of the five electrostatic sensors 112. The process of step S106 is a process of determining whether the composite value ΔAD115T is within the range from the threshold value TH106L to the threshold value TH106U.

Note that the threshold value TH106L may be set to a lower limit value capable of determining that the hand is in contact with the rim 13 based on the composite value ΔAD115T. The threshold value TH106U may be set to an upper limit value capable of determining that the hand is in contact with the rim 13 based on the composite value ΔAD115T.

The specific values of the threshold values TH106L and TH106U may be set to appropriate values based on simulation or actual measurement results in consideration of the areas of the five electrostatic sensors 112, and the dielectric constant, thickness, the stray capacitance, and the like of the decorative member or the like surrounding the electrostatic sensors 112. When the distances between the electrostatic sensors 112 and the rim 13 are different from each other, the threshold value TH106L and the threshold value TH106U may be set to appropriate values in consideration of the difference in distances. This is because a long distance substantially corresponds to a small electrode area.

When it is determined that the composite value ΔAD115T is equal to or greater than the threshold value TH106L and equal to or less than the threshold value TH106U (S102: YES), or when it is determined that the composite value ΔAD112T of the difference values of the five electrostatic sensors 112 is equal to or greater than the threshold value TH106L and equal to or less than the threshold value TH106U (S106: YES), the determination unit 131 determines whether or not the determination results are free from the non-hold determination result (step S107).

When it is determined that it is free from the non-hold determination result (S107: YES), the determination unit 131 determines that the hand is in contact with the upper half of the rim 13 (step S108A).

When it is determined in step S107 that the determination results are not free from the non-hold determination result (S107: NO), the determination unit 131 determines that the hand is not in contact with the upper half of the rim 13 (step S108B).

If the determination unit 131 determines in step S106 that the composite value ΔAD115T is equal to or greater than the threshold value TH106L and greater than the threshold value TH106U (step S106: NO), it determines that the hand is not in contact with the lower half of the rim 13 (non-hold) (step S108B).

When the determination unit 131 finishes the process in step S108A or step S108B, it finishes the hold determination process.

### <Non-Hold Determination Process: FIG. 4D>

The non-hold determination process determines that the hand is not in contact with the rim 13 (non-hold) based on the difference value ΔAD of the electrostatic sensors 111 to 115B. The determination result of the non-hold determination process is used in steps S103 and S107 of FIG. 4C.

FIG. 4D is a flowchart showing an example of a non-hold determination process.

### <Step S111>

The determination unit 131 determines whether a ratio R1 (=ΔAD114A/ΔAD114B) of the difference value ΔAD114A of the electrostatic sensor 114A to the difference value ΔAD114B of the electrostatic sensor 114B is equal to or greater than the threshold value TH111L and equal to or less than the threshold value TH111U (step S111).

The electrostatic sensors 114A and 114B are located on the lateral surface of the spoke 12, the electrostatic sensor 114A is located in the +Z-direction (driver side), and the electrostatic sensor 114B is located in the −Z-direction (side farther from the driver). When a hand is located near the electrostatic sensors 114A and 114B, the difference values ΔAD114A and 114B of the electrostatic sensors 114A and 114B increase. However, the ratio of the difference values ΔAD114A and 114B is different when a hand is located on the outer surface 12A side of the spoke 12 to operate the switch 15 and when a hand is in contact with the rim 13, for example.

For example, when the shapes of the electrostatic sensors 114A and 114B are equal and the decorative members covering the electrostatic sensors 114A and 114B are equal, the difference value ΔAD114A is relatively greater than the difference value ΔAD114B when the switch 15 is operated. When a hand is in contact with the rim 13, the difference values ΔAD114A and 114B are equal.

In order to distinguish between an operation in which the hand is in contact with the outer surface 12A of the spoke 12 and an operation in which the hand is in contact with the rim 13, it is determined whether the ratio R1 of the difference value ΔAD114A of the electrostatic sensor 114A to the difference value ΔAD114B of the electrostatic sensor 114B is within a predetermined range (a range from TH111L to TH111U).

The specific values of the threshold values TH111L and TH111U may be set to appropriate values based on simulation or actual measurement results in consideration of the ratio of the areas of the electrostatic sensors 114A and 114B, and the dielectric constant, thickness, the stray capacitance, and the like of the decorative member or the like surrounding the electrostatic sensors 114A and 114B. When the distance between the electrostatic sensor 114A and the rim 13 is different from the distance between the electrostatic sensor 114B and the rim 13, the threshold value TH111L and the threshold value TH111U may be set to appropriate values in consideration of the difference in distances. This is because a long distance substantially corresponds to a small electrode area. When the rim 13 and the spokes 12 are arranged at different positions in the Z-direction, the threshold values TH111L and TH111U may be set to appropriate values in consideration of the difference in the Z-direction positions.

In the determination in step S111, the electrostatic sensor 114A is an example of the first proximity sensor, and the difference value ΔAD114A is an example of the first sensor value. The electrostatic sensor 114B is an example of the second proximity sensor, and the difference value ΔAD114B is an example of the second sensor value. The ratio R1 (=ΔAD114A/ΔAD114B) is an example of the first ratio.

When the determination unit 131 determines that the ratio R1 is equal to or greater than the threshold value TH111L and equal to or less than the threshold value TH111U (S111: YES), the flow proceeds to step S112.

When the determination unit 131 determines in step S11 that the ratio R1 is equal to or greater than the threshold value TH111L and greater than the threshold value TH111U (S11: NO), it determines that a hand is not in contact with the rim 13 (non-hold) (step S114B). The result of step S114B is used in step S103 of FIG. 4C as a result of determining that the upper rim 13 is not held.

In the process of step S111, the non-hold determination of the upper rim 13 was performed using the electrostatic sensors 114A and 114B. Following step S111, the same process is performed by using the electrostatic sensors 115A and 115B. The description of the process is omitted because it is equivalent to step S111, but when it is determined that the lower rim is not held in this process, the result is used as a non-hold determination result of the lower rim in step S107 of FIG. 4C.

Further, in the process of step S11, as a specific method for determining the non-hold of the upper rim 13, it was determined that the ratio R1 (=ΔAD114A/ΔAD114B) between the difference value ΔAD114A and the difference value ΔAD114B is not between the threshold value TH111L and the threshold value TH111L, but it may be determined by another method. Specifically, the determination may be made by referring to a predetermined determination table based on these calculation methods or actual acquired data, such as when ΔAD114B/ΔAD114A, ΔAD114A/(ΔAD114A+ΔAD114B), ΔAD114B/(ΔAD114A+ΔAD114B) is not within a predetermined range, when |ΔAD114B−ΔAD114A| is equal to or greater than a predetermined value, when ΔAD114A is within a predetermined range of a constant K, ΔAD114B is within a predetermined range of a constant L, and the constant K and the constant L are apart at a value equal to or greater than a predetermined value apart. That is, it is sufficient to determine whether the arrangement of the hand with respect to the electrostatic sensor 114A and the arrangement of the hand with respect to the electrostatic sensor 114B are different values. When the area of the electrostatic sensor 114A and the electrostatic sensor 114B, and the dielectric constant, thickness, stray capacitance, and the like of the decorative member or the like surrounding the electrostatic sensors 114A and 114B are equal, it is sufficient to determine whether the first sensor value and the second sensor value are different values. If the first ratio between the first sensor value and the second sensor value is determined, various calculation and determination methods can be considered, in which the first ratio is outside a predetermined range.

As described above, when the ratio of the areas of the electrostatic sensors 114A and 114B and the like is different, ΔAD114A and ΔAD114B may be different values even if they are the same value.

### <Step S112>

The determination unit 131 determines whether the ratio R2 (=ΔAD113T/ΔAD114AB) of the composite value ΔAD113T of the difference values between the two electrostatic sensors 113 to the composite value ΔAD114AB of the difference values between the electrostatic sensors 114A and 114B is equal to or greater than the threshold value TH112 (step S112).

Since the two electrostatic sensors 113 are treated as capacitors connected in parallel, the composite value ΔAD113T of the difference values of the two electrostatic sensors 113 is the sum of the difference values of the two electrostatic sensors 113. The composite value ΔAD114AB is similar.

The two electrostatic sensors 113 are positioned on the outer surface 12A of the spoke 12, and the electrostatic sensors 114A and 114B are positioned on the lateral surface of the spoke 12. Therefore, for example, the ratio of the composite value ΔAD113T of the two electrostatic sensors 113 to the composite value ΔAD114AB of the electrostatic sensors 114A and 114B is different when the hand is positioned in the +Z-direction of the rim 13 and when the hand is in contact with the rim 13. When the hand is positioned in the +Z-direction of the rim 13, the composite value ΔAD113T is much larger than the composite value ΔAD114AB, and when the hand is in contact with the rim 13, the composite value ΔAD113T and the composite value ΔAD114AB are closer to each other than when the hand is positioned in the +Z-direction of the rim 13.

Therefore, in step S112, a ratio R2 (=ΔAD113T/ΔAD114AB) is used to distinguish between the case where the hand is positioned in the +Z-direction of the rim 13 and the case where the hand is in contact with the rim 13. When the ratio R2 is less than the threshold value TH112, it is determined that the hand is in contact with the rim 13, and when the ratio R2 is equal to or greater than the threshold value TH112, it is determined that the hand is positioned in the +Z-direction of the rim 13 and the hand does not hold the rim 13.

The specific value of the threshold value TH112 may be set to an appropriate value based on simulation or actual measurement results in consideration of the ratio of the areas of the two electrostatic sensors 113, the areas of the electrostatic sensors 114A and 114B, the ratio of the areas of the two electrostatic sensors 113 and the electrostatic sensors 114A and 114B, the dielectric constant, thickness, the stray capacitance, and the like of the decorative member or the like surrounding the two electrostatic sensors 113, and the dielectric constant, thickness, the stray capacitance, and the like of the decorative member or the like surrounding the electrostatic sensors 114A and 114B. When the distances between each of the electrostatic sensors 113 and the rim 13 are different from each other, the threshold value TH112 may be set to an appropriate value in consideration of the difference in distances. This is because a long distance substantially corresponds to a small electrode area. When the rim 13 and the spokes 12 are arranged at different positions in the Z-direction, the threshold values TH111L and TH111U may be set to appropriate values in consideration of the difference in the Z-direction positions.

In the process of step S112, the electrostatic sensor 114A is an example of the first proximity sensor, and the difference value ΔAD114A is an example of the first sensor value. The electrostatic sensor 114B is an example of the second proximity sensor, and the difference value ΔAD114B is an example of the second sensor value. The composite value ΔAD114AB is an example of the sum of the first sensor value and the second sensor value. The two electrostatic sensors 113 are examples of the third proximity sensor, and the composite value 113T is an example of the third sensor value. The ratio R2 (=ΔAD113T/ΔAD114AB) is an example of a second ratio. The threshold value TH112 is an example of the first predetermined threshold value.

Further, in the process of step S112, the two electrostatic sensors 113 are examples of the first proximity sensors, and the composite value 113T can be regarded as an example of the first sensor value. In this case, the electrostatic sensors 114A and 114B are examples of the second proximity sensors, and the composite value AD114AB is an example of the second sensor value. The ratio R2 of the composite value 113T to the composite value AD114AB is an example of the first ratio. The threshold value TH112 is an example of the first predetermined threshold value.

If there is an electrostatic sensor similar to the electrostatic sensor 113 directly behind the outer surface 12B of the spoke 12, the electrostatic sensor directly behind the outer surface 12B of the spoke 12 may be used instead of the electrostatic sensor 113.

When the determination unit 131 determines that the ratio R2 is equal to or greater than the threshold value TH112 (S112: YES), it determines that the hand is not in contact with the rim 13 (non-hold) (step S114B). The result of step S114B is used in step S103 of FIG. 4C as a determination result of non-hold.

When the determination unit 131 determines that the ratio R2 is less than the threshold value TH112 (S112: NO), the flow proceeds to step S113.

In the process of step S112, the non-hold determination of the upper rim 13 was performed using the electrostatic sensors 114A and 114B and the two electrostatic sensors 113. Following step S112, the same process is performed by using the electrostatic sensors 115A and 115B and the two electrostatic sensors 113. The description of the process is omitted because it is equivalent to step S112, but when it is determined that the lower rim is not held in this process, the result is used as a non-hold determination result of the lower rim in step S107 of FIG. 4C.

Further, in the process of step S112, as a specific method for determining the non-hold of the upper rim 13, it is determined that the ratio R2 (=ΔAD113T/ΔAD114AB) of the composite value ΔAD113T of the difference values of the two electrostatic sensors 113 to the composite value ΔAD114AB of the difference values of the electrostatic sensors 114A and 114B is equal to or greater than the threshold value TH112, but non-hold determination may be performed using another method. Specifically, the determination may be made by referring to a predetermined determination table based on these calculation methods or actual acquired data, such as when ΔAD114AB/ΔAD113T is equal to or less than a predetermined value, when ΔAD113T/(ΔAD113T+ΔAD114AB) is equal to and greater than a predetermined value and ΔAD114AB/(ΔAD114A+ΔAD114B) is equal to or less than the predetermined value, when ΔAD113T−ΔAD114AB is equal to or greater than a predetermined value, or when ΔAD114AB is within a predetermined range of the constant K′, ΔAD113T is within a predetermined range of the constant L′, and the constant K′ and the constant L′ are apart at a value equal to or greater than a predetermined value apart. That is, it is sufficient to determine whether ΔAD113T is a value to be determined to be large relative to ΔAD114AB, and various calculation and determination methods can be considered that can make the ratio R2 (=ΔAD113T/ΔAD114AB) equal to or greater than a predetermined value.

As described above, when the ratio of the areas of the two electrostatic sensors 113 and the areas of the electrostatic sensors 114A and 114B are different and the areas of the electrostatic sensors 114A and 114B are larger than the areas of the two electrostatic sensors 113, ΔAD113T and ΔAD114AB may be different values even if they are the same value, ΔAD113T may be determined to be greater.

### <Step S113>

The determination unit 131 determines whether the ratio R3 (=ΔAD111/ΔAD114AB) of the difference value ΔAD111 of the electrostatic sensor 111 to the composite value ΔAD114AB of the electrostatic sensors 114A and 114B is equal to or larger than the threshold value TH113 (step S113).

For example, when pressing a reset button of a trip meter, a hand may be inserted between the hub 11 and the left and right spokes 12 of the steering wheel 10 and the upper half portion of the rim 13. In order to distinguish such an operation from an operation in which a hand is in contact with the rim 13, the process of step S113 is provided.

When a hand is inserted between the hub 11 and the left and right spokes 12 and the upper half portion of the rim 13, the hand approaches the hub 11, so that the difference value ΔAD111 of the electrostatic sensor 111 becomes relatively larger than the composite value ΔAD114AB of the electrostatic sensors 114A and 114B. When the hand is in contact with the upper half of the rim 13, the hand moves away from the hub 11, so that the difference between the difference value ΔAD111 and the composite value ΔAD114AB becomes smaller than when the hand is inserted between the hub 11, the left and right spokes 12, and the upper half portion of the rim 13.

Therefore, the determination unit 131 determines that the hand is in contact with the rim 13 when the ratio R3 is less than the threshold value TH113, and determines that the hand is not in contact with the upper rim 13 when the ratio R3 is greater than or equal to the threshold value TH113.

The specific value of the threshold value TH113 may be set to an appropriate value based on simulation or actual measurement results in consideration of the positional relationship between the rim 13 and the electrostatic sensors 111, 114A, and 114B, the area of the electrostatic sensor 111, the ratio of the areas of the electrostatic sensors 114A and 114B, the ratio of the areas of the electrostatic sensor 111 to the area of the electrostatic sensors 114A and 114B, the dielectric constant, thickness, the stray capacitance, and the like of the decorative member or the like surrounding the electrostatic sensor 111, and the dielectric constant, thickness, the stray capacitance, and the like of the decorative member or the like surrounding the electrostatic sensors 114A and 114B. In addition, the threshold value TH113 may be set to an appropriate value in consideration of a difference between a distance between the electrostatic sensor 111 and the rim 13 and a distance between the electrostatic sensor 114A and the rim 13, and a difference between a distance between the electrostatic sensor 111 and the rim 13 and the electrostatic sensor 114B and the rim 13. When the rim 13 and the spoke 12 are arranged at different positions in the Z-direction, the threshold values TH111L and TH111U may be set to appropriate values in consideration of the difference in the Z-direction positions.

In the process of step S113, the electrostatic sensors 114A and 114B are examples of the second proximity sensors provided inside the spoke 12 along the spoke lateral surface connecting the outer surface 12A (first spoke outer surface) of the spoke 12 and the outer surface 12B (second spoke outer surface) opposite the outer surface 12A, and the composite value ΔAD114AB is an example of the second sensor value. The electrostatic sensor 111 is an example of the third proximity sensor provided inside the hub 11 along the hub lateral surface connecting the first hub outer surface on the driver side of the hub 11 and the second hub outer surface opposite the first hub outer surface, and the difference value ΔAD111 of the electrostatic sensor 111 is an example of the third sensor value. The ratio R3 (=ΔAD111/ΔAD114AB) is an example of a second ratio, and the threshold value TH113 is an example of the second predetermined threshold value.

The electrostatic sensor 111 is an example of the first proximity sensor provided inside the hub 11 along the hub lateral surface connecting the first hub outer surface and the second hub outer surface opposite the first hub outer surface. The difference value ΔAD111 of the electrostatic sensor 111 is an example of the first sensor value. In this case, the electrostatic sensors 114A and 114B are examples of the second proximity sensors provided inside the spoke 12 along the lateral surface 12C (spoke lateral surface) connecting the driver side surface 12A (first spoke outer surface) of the spoke 12 and the outer surface 12B (second spoke outer surface) opposite the outer surface 12A. The composite value ΔAD114AB is an example of the second sensor value.

When the determination unit 131 determines that the ratio R3 (=ΔAD111/ΔAD114AB) is equal to or greater than the threshold value TH113 (S113: YES), it determines that the hand is not in contact with the rim 13 (non-hold) (step S114B). The result of step S114B is used in step S103 of FIG. 4C as a determination result of non-hold.

If the determination unit 131 determines in step S113 that the ratio R3 (=ΔAD111/ΔAD114AB) is less than the threshold value TH113 (step S113: NO), it determines that the hand is in contact with the rim 13 (step S114A). Determining that the hand is in contact with the rim 13 is synonymous with determining that the hand is not non-hold, and there is no determination result of non-hold.

When the processes in step S114A or step S114B are completed, the determination unit 131 terminates the non-hold determination process.

In the process in step S113, as a specific method for determining the non-hold of the upper rim, it is determined that the ratio R3 (=ΔAD111/ΔAD114AB) of the difference value ΔAD111 of the electrostatic sensor 111 to the composite value ΔAD114AB of the electrostatic sensors 114A and 114B is greater than or equal to the threshold value TH113, but other methods may be used.

Specifically, the determination may be made by referring to a predetermined determination table based on the calculation method or actual acquired data such as that ΔAD114AB/ΔAD111 is equal to or less than a predetermined value, or that ΔAD111/(ΔAD111+ΔAD114AB) is equal to or more than a predetermined value, ΔAD114AB/(ΔAD111+ΔAD114AB) is equal to or less than a predetermined value, or that ΔAD111-ΔAD114AB is equal to or more than a predetermined value, or that ΔAD114AB is within a predetermined range of the constant K″, ΔAD111 is within a predetermined range of the constant L″, and the constant L″ is not more than a predetermined value from the constant K″. That is, it is sufficient to determine whether ΔAD111 is a value to be determined to be large relative to ΔAD114AB, and various calculation and determination methods can be considered that can make the ratio R3 (=ΔAD111/ΔAD114AB) equal to or greater than a predetermined value.

As described above, when the ratio of the area of the electrostatic sensor 111 to the areas of the electrostatic sensors 114A and 114B is different and the area of the electrostatic sensors 114A and 114B is larger than the area of the two electrostatic sensors 111, even if ΔAD111 and ΔAD114AB are the same value, ΔAD111 may be a value to be determined as large.

### <Determination Process for Distinguishing Between Driver's Hand and Driver's Leg>

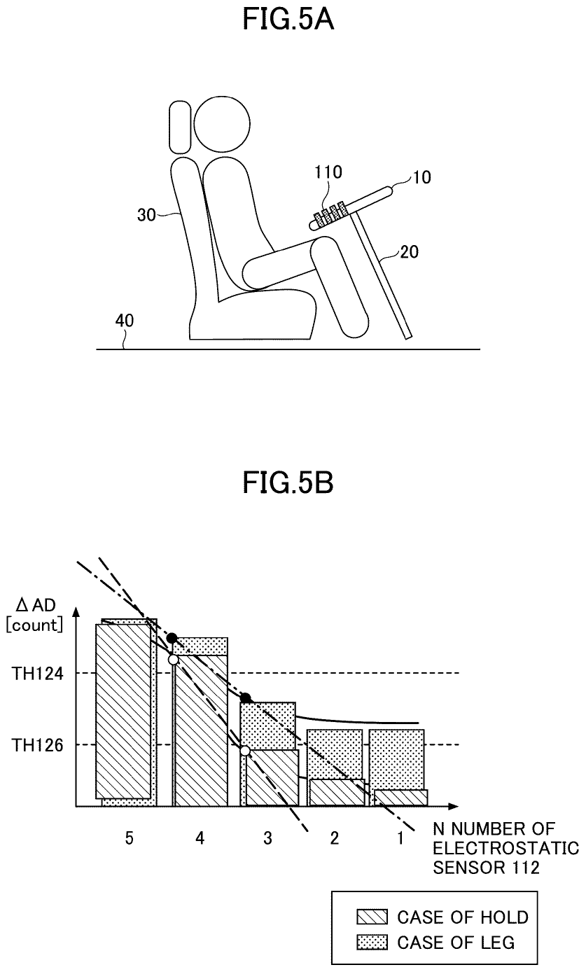

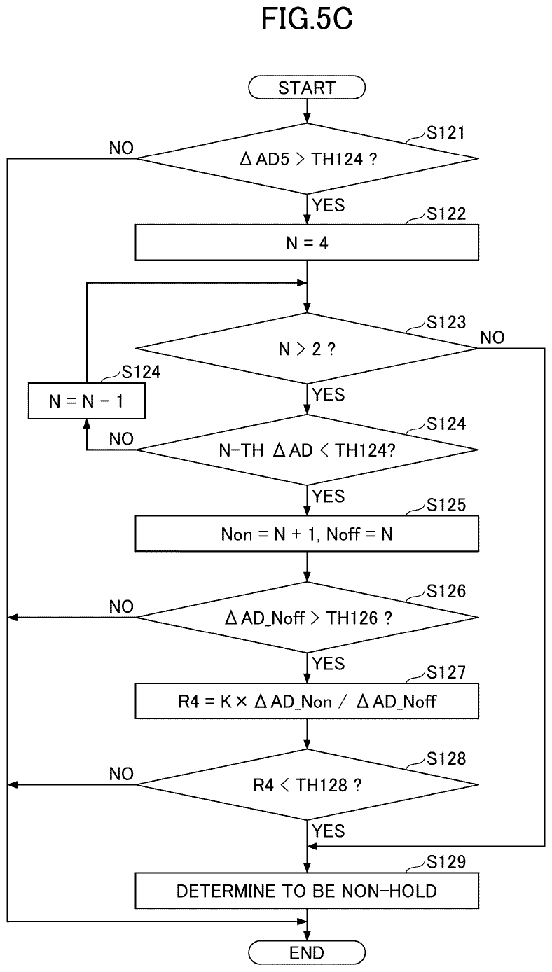

FIG. 5A is a drawing illustrating an example of a positional relationship between the driver's leg and the steering wheel 10.

At the upper rim 13, a non-hold determination is performed assuming an action such as pressing the reset button of the trip meter, and at the lower rim 13, the following non-hold determination is performed assuming a case where the leg approaches the steering wheel 10.

The steering wheel 10 is attached to the steering shaft 20, and the driver is seated on a seat 30. FIG. 5A shows a floor 40 of the vehicle body. In such a case, when the driver raises a knee or leg, the leg approaches the steering wheel 10, and the difference value ΔAD is affected, so that YES may be determined at step S105 or step S106.

As shown in FIG. 5A, when the driver does not raise the leg but extends the leg forward, the leg is separated from the steering wheel 10 by a predetermined distance or more, so that the difference values ΔAD of the five electrostatic sensors 112 are small. In this state, when the hand is in contact with the rim 13, the difference values ΔAD of the fifth and fourth electrostatic sensors 112 which are close to the rim 13 among the five electrostatic sensors 112 greatly increase, while the difference values ΔAD of the first and second electrostatic sensors 112 which are close to the hub 11 do not significantly increase.

When the leg approaches the steering wheel 10, the leg approaches all of the five electrostatic sensors 112, so that the difference values ΔAD of the five electrostatic sensors 112 increase and the differences therebetween become small.

Here, as an example, a configuration in which five electrostatic sensors 112 are provided will be described, but a plurality of electrostatic sensors 112 is sufficient.

FIG. 5B is a drawing illustrating an example of a distribution of the difference values ΔAD of the five electrostatic sensors 112. The horizontal axis represents the number N of the electrostatic sensors 112, and the vertical axis represents the difference value ΔAD. The threshold value TH124 shown on the vertical axis is set to a value exceeding the difference value ΔAD of the fifth electrostatic sensor 112 among the five electrostatic sensors 112 when the leg is raised. The threshold value TH124 is an example of the first sensor threshold value. In addition, even when a hand is actually in contact with the rim 13, the difference value ΔAD of the fifth electrostatic sensor among the five electrostatic sensors 112 also exceeds the threshold value TH124.

The threshold value TH126 shown on the vertical axis is a threshold value applied to the difference value ΔAD of any of the fourth to first electrostatic sensors 112 among the five electrostatic sensors 112 positioned on the center side of the steering wheel 10. More specifically, the threshold value TH126 is a threshold value applied to the electrostatic sensor 112 (third electrostatic sensor 112 in the example of FIG. 5B) adjacent to the center side of the steering wheel 10 of the electrostatic sensor 112 (fourth electrostatic sensor 112 in the example of FIG. 5B) positioned on the center side of the steering wheel 10 that exceeds the threshold value TH124, and is set to a value that can be considered such that a hand is always in contact with the rim 13 when it is smaller than the threshold value TH126. That is, when the leg approaches the electrostatic sensor 112, since the leg is long and extends along the center side of the steering wheel 10, the difference value ΔAD of the electrostatic sensor 112 gradually decreases toward the center side of the steering wheel 10. However, when the rim 13 is held by a hand, the range where the hand exists is limited, and therefore, depending on the position of the hand and the positional relationship between the individual electrodes of the electrostatic sensor 112, the difference value ΔAD may rapidly decrease toward the center side of the steering wheel 10. Therefore, by setting the threshold value TH126 in this manner, it is possible to identify the hold of the hand. The threshold value TH126 is an example of the second sensor threshold value.

The difference values ΔAD of the first to fifth electrostatic sensors 112 in the case where the hand is in contact with the rim 13 (hold) are shown by hatching, and the difference values ΔAD of the first to fifth electrostatic sensors 112 in the case where the leg approaches the rim 13 (non-hold) are shown by dots.

As shown in FIG. 5B, in the case where the hand is in contact with the rim 13 (hold), the hand exists at a position close to the rim, but the hand does not exist at a position close to the hub 11. In the difference values ΔAD (hatching) of the first to fifth electrostatic sensors 112, the difference values ΔAD of the fifth and fourth electrostatic sensors 112 close to the rim 13 greatly exceed the threshold value TH124, and the difference values ΔAD of the first to third electrostatic sensors 112 do not exceed the threshold value TH126. Therefore, the change in the difference value ΔAD from the fifth electrostatic sensor 112 to the first electrostatic sensor 112 is large. In particular, the slope (broken line) between the difference value ΔAD of the fourth electrostatic sensor 112 greater than the threshold value TH124 and the difference value ΔAD of the third electrostatic sensor 112 smaller than the threshold value TH124 is large.

Further, when a leg is close to the rim 13 (non-hold), the leg is present at a position close to the rim, and the leg is also present at a position close to the hub 11. As for the difference values ΔAD (dots) of the first to fifth electrostatic sensors 112, the difference values ΔAD of the fifth and fourth electrostatic sensors 112 close to the rim 13 greatly exceed the threshold value TH124, and the difference values ΔAD of the electrostatic sensors 112 from the first point to the third point do not exceed the threshold value TH124. This tendency is similar to that in the case where a hand is in contact with the rim 13 (hold). However, in the case where a leg approaches the rim 13 (non-hold), the difference values ΔAD (dots) of the first to fifth electrostatic sensors 112 are larger than the difference values ΔAD of the first to third electrostatic sensors 112 in the case where a hand is in contact with the rim 13 (hold). Therefore, the slope (dash-dot line) between the fourth difference value ΔAD which is greater than the threshold value TH124 and the third difference value ΔAD which is smaller than the threshold value TH124, is small.

The sensor device 100 distinguishes between a state where a hand is in contact with the rim 13 and a state where a leg approaches the rim 13 by utilizing the characteristics of the difference values ΔAD of the five electrostatic sensors 112.

### <Flowchart>

FIG. 5C is a flowchart illustrating an example of a determination process for distinguishing the driver's hand from the driver's leg. N is a variable which can take five values from 1 to 5 and indicates the number of the electrostatic sensor 112.

The determination unit 131 compares the sensor values with the threshold value TH124 in the order from the sensor value of the electrostatic sensor 112 on the rim 13 side, that is, the fifth electrostatic sensor 112, to the electrostatic sensor 112 on the hub 11 side.

Specifically, upon starting the process, the determination unit 131 determines whether or not the difference value ΔAD5 of the fifth electrostatic sensor 112 located furthest in the −Y-direction is greater than the threshold value TH124 (step S121).

The determination unit 131 determines that the difference value ΔAD5 is not greater than the threshold value TH124 (S121: NO), that is, when it is equal to or smaller than TH124, it determines that the leg does not approach the lower side of the rim 13, and ends the determination process of FIG. 5C.

When the determination unit 131 determines that the difference value ΔAD5 is greater than the threshold value TH124 (S121: YES), N is set to 4 (step S122). That is, the number of the electrostatic sensor 112 that is second closest to the rim 13 is selected.

The determination unit 131 determines whether the number N is larger than 2 (step S123). This is a process for distinguishing a hand from a leg. When the hand is in contact with the rim 13, it is determined whether the number N is larger than two or not because the difference value ΔAD becomes smaller than the threshold value TH124 until the third electrostatic sensor 112 in the next step S124. In other words, when the difference value ΔAD of the electrostatic sensors 112 is greater than the threshold value TH124 up to the third step, it is determined that a human body is present beyond the range where the hand is present, and it is determined that a leg is present and the steering wheel 10 is not held (step S123: NO).

When it is determined that the number N is larger than two (step S123: YES), the determination unit 131 determines whether the difference value ΔAD of the electrostatic sensor 112 of number N is smaller than the threshold value TH124 or not (step S124).

The five electrostatic sensors 112 are an example of the fourth proximity sensor. The five electrostatic sensors 112 are also an example of a plurality of proximity sensors.

When it is determined that the difference value ΔAD of the electrostatic sensor 112 of number N is not smaller than the threshold value TH124 (step S124: NO), the determination unit 131 decrements N (step S124A). That is, N becomes N−1. When the determination unit 131 finishes the process of step S124A, the flow proceeds to step S123.

When the determination unit 131 determines in step S124 that the difference value ΔAD of the N-th electrostatic sensor 112 is smaller than the threshold value TH124 (S124: YES), Non is set to N+1 and Noff is set to N (step S125). The threshold value TH124 is between Non and Noff, numbers N of the electrostatic sensors 112 of two difference values ΔAD, and in the example shown in FIG. 5B, Non is 4 and Noff is 3.

The determination unit 131 determines whether the Noff-th difference value ΔAD_Noff is greater than the threshold value TH126 (step S126).

When the determination unit 131 determines that the difference value ΔAD_Noff is not greater than the threshold value TH126 (S126: NO), that is, when it is smaller than the threshold value TH126, it ends the determination process shown in FIG. 5C. Since there is no influence of the leg and the hand is in contact with the rim 13, the determination process ends.

If the determination unit 131 determines in step S126 that the difference value ΔAD_Noff is larger than the threshold value TH126 (YES in step S126), the determination unit calculates a ratio R4 (step S127). The ratio R4 is K×ΔAD_Non/ΔAD_Noff, which is an example of the third ratio. The constant K has a negative predetermined value. The ratio R4 corresponds to slopes indicated by a broken line and a dash-dot line in FIG. 5B.

The determination unit 131 determines whether the ratio R4 is smaller than the threshold value TH128 (step S128). The threshold value TH128 is a value capable of distinguishing a slope in the case of a hold indicated by a broken line in FIG. 5B from a slope in the case of a leg indicated by a dash-dot line, and is an example of the third predetermined threshold value.

The specific value of the threshold value TH128 may be set to an appropriate value based on a simulation or an actual measurement result in consideration of the ratio of the area of the five electrostatic sensors 112, the distance of each of the five electrostatic sensors 112 from the rim 13, and the dielectric constant, thickness, and stray capacitance of the decorative member surrounding the five electrostatic sensors 112.

When the determination unit 131 determines that the ratio R4 is not smaller than the threshold value TH128 (S128: NO), that is, the slope is large, the determination unit 131 ends the determination process of FIG. 5C. Since the slope is large, the effect of the leg is not generated and the hand is in contact with the rim 13, and the determination process is ended.

If the determination unit 131 determines at step S128 that the ratio R4 is smaller than the threshold value TH128 (step S128: YES), the determination unit determines that the grip is not held (step S129). This is because the slope is reduced under the influence of the leg.

When the rim is held by the hand, the range in which the hand exists is limited, and therefore, it is assumed that there are cases in which the difference value ΔAD rapidly decreases and cases in which the difference value ΔAD decreases at a slope greater than a predetermined value depending on the position of the hand and the positional relationship between the individual electrodes of the electrostatic sensor 112. When the difference value ΔAD rapidly decreases, the result is NO in step S126, and when the difference value ΔAD decreases at a slope greater than a predetermined value, the result is NO in step S128.

Further, as a specific example of a value for determining that a proximity sensor on the hub 11 side exceeds a predetermined level, the present embodiment exemplifies a case in which a value of the third electrostatic sensor 112 is equal to or greater than the threshold value TH124 (S123: NO), and a case in which, among adjacent electrodes, a difference value ΔAD is such that one electrode is equal to or greater than the threshold value TH124 and the other electrode is equal to or less than the threshold value TH124, and a slope of the electrodes is smaller than the threshold value TH128 (S128: YES). However, the determination is not limited to these examples.

Further, as a specific example of a value for determining that a proximity sensor on the hub 11 side is less than a predetermined level, the present embodiment exemplifies a case in which, among adjacent electrodes, a difference value ΔAD is such that one electrode is equal to or greater than the threshold value TH124 and the other electrode is equal to or less than the threshold value TH124, and the difference value ΔAD equal to or less than the threshold value TH124 is less than the threshold value TH126 (S126: NO), and a case in which, among adjacent electrodes, a difference value ΔAD is such that one electrode is equal to or greater than the threshold value TH124 and the other electrode is equal to or less than the threshold value TH124, and a slope of the electrodes is not smaller than the threshold value TH128, that is, the slope is equal to or greater than the threshold value TH128 (S128: NO). However, the determination is not limited to these examples.

Thus, the determination process shown in FIG. 5C is completed.

### <Modification>

In the above embodiment, whether the difference value ΔAD is greater than the predetermined threshold value is determined in S101, S102, S105, and S106, and if any of the values exceeds the predetermined threshold value, it is determined that the rim 13 is held or considered to be held. If the determination result of non-hold is obtained in steps S111 to S114B and steps S121 to S129 of the subroutine, the determination result is changed to non-hold in step S103 or step S107. In steps S11 to S114B and steps S121 to S129 of the subroutine, if the determination result of non-hold is not obtained, it is determined to be held or considered to be held. However, the form is not limited.

For example, only the processes of steps S111 to S113, only the processes of steps S121 to S129, or only one of the processes may be performed. In this case, the hold may be determined when any of YES in S11, NO in S112, NO in S113, NO in S126, and NO in S128 is selected.

Also, the holding may be determined when the hold is determined by the subroutine, and the non-hold may be determined when the hold is not determined by the subroutine.

In the present embodiment, the difference value ΔAD obtained by subtracting a reference value corresponding to the noise floor from the output corresponding to the capacitance of the electrostatic sensor 110 is used, but the present disclosure is not limited to this. For example, the output value corresponding to the capacitance of the electrostatic sensor 110 may be used as it is, or the amount of change in of the difference value ΔAD obtained by subtracting the difference value ΔAD before a predetermined time from the difference value ΔAD at the present time, or the amount of change in of the sensor value of the electrostatic sensor 110 obtained by subtracting the output value corresponding to the capacitance of the electrostatic sensor 110 before a predetermined time from the output value corresponding to the capacitance of the electrostatic sensor 110 at the present time may be used.

In addition, since when the value of the denominator is zero in the calculation of the ratio, the calculated value becomes infinity, in order to prevent this, when the denominator is zero, the calculated value may be replaced with a sufficiently small value.

### Effect

The sensor device 100 includes the electrostatic sensor 114A (first proximity sensor) configured to output a first sensor value (difference value ΔAD) that varies according to a degree of proximity of a target object and provided inside one of the hub 11 and the spoke 12 of the steering wheel 10 (steering operation unit) including the hub 11, the spoke 12, and the rim 13 (grip), the electrostatic sensor 114A (first proximity sensor) being disposed along a first lateral portion of the lateral surface of the one of the hub 11 and the spoke 12, the lateral surface connecting the first outer surface on the driver side and the second outer surface opposite the first outer surface, and the first lateral portion being located closer to the first outer surface than to the second outer surface, the electrostatic sensor 114B (second proximity sensor) configured to output a second sensor value (difference value ΔAD) that varies according to a degree of proximity of the target object and provided inside the one of the hub 11 and the spoke 12, the second proximity sensor being disposed along a second lateral portion of the lateral surface, and the second lateral portion being located closer to the second outer surface than to the first outer surface, and the determination unit 131 configured to determine at least one of that the target object is in contact with the rim 13 (grip) when the first sensor value and the second sensor value are equal to or greater than a threshold value and are values indicating that an arrangement of the target object relative to the electrostatic sensor 114A (first proximity sensor) and an arrangement of the target object relative to the electrostatic sensor 114B (second proximity sensor) are regarded as an equivalent positional relationship, or an amount of change in the first sensor value and an amount of change in the second sensor value are equal to or greater than a threshold value and are values indicating that an arrangement of the target object relative to the electrostatic sensor 114A (first proximity sensor) and an arrangement of the target object relative to the electrostatic sensor 114B (second proximity sensor) are regarded as an equivalent positional relationship, and that the target object is not in contact with the rim 13 (grip) when the first sensor value and the second sensor value are values indicating that an arrangement of the target object relative to the electrostatic sensor 114A (first proximity sensor) and an arrangement of the target object relative to the electrostatic sensor 114B (second proximity sensor) are regarded as different positional relationships, or an amount of change in the first sensor value and an amount of change in the second sensor value are values indicating that an arrangement of the target object relative to the electrostatic sensor 114A (first proximity sensor) and an arrangement of the target object relative to the electrostatic sensor 114B (second proximity sensor) are regarded as different positional relationships.

The arrangement of the electrostatic sensor and the object means the angle and the distance of the object with respect to the surface of the electrostatic sensor, and when the object is not in contact with the rim 13 (grip), the object is positioned in the direction perpendicular to the surfaces of the electrostatic sensor 114A and the electrostatic sensor 114B, and the distance between the electrostatic sensor 114A and the electrostatic sensor 114B and the object is the same, so that the arrangement of the object with respect to the electrostatic sensor 114A (first proximity sensor) and the arrangement of the object with respect to the electrostatic sensor 114B (second proximity sensor) have the same arrangement relationship. When the object is not in contact with the rim 13 (grip), for example, when the hand is positioned on the side of the outer surface 12A of the spoke 12 in order to operate the switch 15, the distance of the electrostatic sensor 114A to the object is short, differing from the distance of the electrostatic sensor 114B to the object, and the arrangement of the object with respect to the first sensor and the arrangement of the object with respect to the second sensor are different.

On the basis of the difference value ΔAD of the electrostatic sensor 114A of the first side portion and the difference value ΔAD of the electrostatic sensor 114B of the second side portion, it is possible to distinguish an action in which the hand is in contact with the first outer surface of the hub 11 or the spoke 12 from an action in which the hand is in contact with the rim 13.

Therefore, it is possible to provide the sensor device 100 capable of detecting with high accuracy that the rim 13 (grip) of the steering wheel 10 (steering operation unit) is held.

Further, the first proximity sensor and the second proximity sensor may be electrostatic sensors 114A and 114B, respectively, and the first sensor value and the second sensor value may be electrostatic capacitance values (difference values ΔAD). Therefore, by using the difference value ΔAD obtained from the electrostatic sensors 114A and 114B, it is possible to more easily and reliably distinguish between an action in which the hand is in contact with the first outer surface of the hub 11 or spoke 12 and an action in which the hand is in contact with the rim 13. Therefore, it is possible to provide the sensor device 100 that can detect with high accuracy that the rim 13 (grip) of the steering wheel 10 (steering operation unit) is held.

When the first ratio R1 between the first sensor value and the second sensor value is obtained, the determination unit 131 is configured to determine that the first sensor value and the second sensor value are values indicating that an arrangement of the target object relative to the electrostatic sensor 114A (first proximity sensor) and an arrangement of the target object relative to the electrostatic sensor 114B (second proximity sensor) are regarded as an equivalent positional relationship and the target object is in contact with the rim 13 (grip), when the first ratio R1 is within a predetermined range.

When the first ratio R1 between the first sensor value and the second sensor value is obtained, the determination unit 131 is configured to determine that the values indicate that an arrangement of the target object relative to the electrostatic sensor 114A (first proximity sensor) and an arrangement of the target object relative to the electrostatic sensor 114B (second proximity sensor) are regarded as different positional relationships and the target object is not in contact with the rim 13 (grip), when the first ratio is not within the predetermined range.

Therefore, it is possible to provide the sensor device 100 capable of detecting with high accuracy that the rim 13 (grip) of the steering wheel 10 (steering operation unit) is held.

The sensor device 100 may further include the electrostatic sensor 113 (third proximity sensor) that may output a third sensor value (difference value ΔAD) that varies according to a degree of proximity of the target object and provided inside the one of the hub 11 and the spoke 12, along the first outer surface or the second outer surface, wherein the determination unit 131 may, in an event that the target object is determined to be in contact with the rim 13 (grip), determine that the target object is in contact with the rim 13 (grip) when the second ratio R2 of the third sensor value to a sum of the first sensor value and the second sensor value is less than a first predetermined threshold value, and determine that the target object is not in contact with the rim 13 (grip) when the second ratio R2 is equal to or greater than the first predetermined threshold value. In addition to the determination based on the first ratio R1, the electrostatic sensor 113 can be used to determine, based on the second ratio R2, between a case where the hand is positioned in the +Z-direction of the rim 13 and a case where the hand is in contact with the rim 13. Therefore, the sensor device 100 can detect with higher accuracy that the rim 13 (grip) of the steering wheel 10 (steering operation section) is held by performing the determination based on the second ratio R2 in addition to the determination based on the first ratio R1.

The sensor device 100 includes an electrostatic sensor 113 (first proximity sensor) configured to output a first sensor value (difference value ΔAD) that varies according to a degree of proximity of the target object and provided inside one of the hub 11 and the spoke 12 of the steering wheel 10 (steering operation unit) including the hub 11, the spoke 12, and the rim 13 (grip), the electrostatic sensor 113 (first proximity sensor) being disposed along the first outer surface on the driver side of the one of the hub 11 and the spoke 12 or the second outer surface opposite the first outer surface, the electrostatic sensors 114A and 114B (second proximity sensors) each configured to output a second sensor value (difference value ΔAD) that varies according to a degree of proximity of the target object and provided inside the one of the hub 11 and the spoke 12, the second proximity sensor being disposed along a lateral surface connecting the first outer surface and the second outer surface, and the determination unit 131 configured to determine at least one of that the target object is in contact with the rim 13 (grip) when the second sensor value is regarded as a value greater than the first sensor value, or an amount of change in the second sensor value is regarded as a value greater than an amount of change in the first sensor, and that the target object is not in contact with the rim 13 (grip) when the second sensor value is regarded as a value less than the first sensor value, or an amount of change in the second sensor value is regarded as a value less than an amount of change in the first sensor. The electrostatic sensor 113 can be used to determine a case where the hand is positioned in the +Z-direction of the rim 13 from a case where the hand is in contact with the rim 13 based on the first ratio R2.

Therefore, it is possible to provide the sensor device 100 capable of detecting with high accuracy that the rim 13 (grip) of the steering wheel 10 (steering operation unit) is held.

The first proximity sensor may be the electrostatic sensor 113, the second proximity sensors may be the electrostatic sensors 114A and 114B, and the first sensor value and the second sensor value may be electrostatic capacitance values (difference values ΔAD). Therefore, by using the difference value ΔAD obtained from the electrostatic sensor 113 and the electrostatic sensors 114A and 114B, it is possible to more easily and reliably distinguish between a case where the hand is positioned in the +Z-direction of the rim 13 and a case where the hand is in contact with the rim 13. Therefore, it is possible to provide the sensor device 100 capable of detecting with higher accuracy that the rim 13 (grip) of the steering wheel 10 (steering operation unit) is held.

When the first ratio R2 of the first sensor value to the second sensor value is obtained, the determination unit 131 is configured to determine that the second sensor value is regarded as a value greater than the first sensor value and the target object is in contact with the rim 13 (grip) when the first ratio R2 is less than a first predetermined threshold value or equal to or less than the first predetermined threshold value.

The determination unit 131 is configured to determine that the second sensor value is regarded as a value less than the first sensor value and the target object is not in contact with the rim 13 (grip) when the first ratio R2 is more than the first predetermined threshold value or equal to or more than the first predetermined threshold value.

Therefore, it is possible to provide the sensor device 100 capable of detecting with high accuracy that the rim 13 (grip) of the steering wheel 10 (steering operation unit) is held.

The sensor device 100 may further include the electrostatic sensor 111 (third proximity sensor) that may output a third sensor value (difference value ΔAD) that varies according to a degree of proximity of the target object and provided inside the hub 11, along the hub lateral surface connecting the first hub outer surface of the hub 11 on the driver side and the second hub outer surface opposite the first hub outer surface, wherein the electrostatic sensors 114A and 114B (second proximity sensors) are provided inside the spoke 12, along the spoke lateral surface connecting the first spoke outer surface of the spoke 12 on the driver side and the second spoke outer surface opposite the first spoke outer surface, the electrostatic sensor 111 (third proximity sensor) is provided adjacent to the electrostatic sensors 114A and 114B (second proximity sensors), and the determination unit 131 may, in an event that the target object is determined to be in contact with the rim 13 (grip), determine that the target object is in contact with the rim 13 (grip) when the second ratio R3 of the third sensor value to the second sensor value is less than a second predetermined threshold value, and determine that the target object is not in contact with the rim 13 (grip) when the second ratio is equal to or greater than the second predetermined threshold value. Therefore, the sensor device 100 can detect with higher accuracy that the rim 13 (grip) of the steering wheel 10 (steering operation unit) is held by performing the determination based on the second ratio (R3) in addition to the determination based on the first ratio R2. The operation of inserting a hand between the hub 11 and the left and right spokes 12 of the steering wheel 10 (steering operation unit) and the upper half portion of the rim 13 can be distinguished from the operation of touching the rim 13. Therefore, the sensor device 100 can detect with higher accuracy that the rim 13 (grip) of the steering wheel 10 (steering operation unit) is held by performing the determination based on the second ratio R3 in addition to the determination based on the first ratio R2.

The sensor device 100 includes the electrostatic sensor 111 (first proximity sensor) configured to output a first sensor value (difference value ΔAD) that varies according to a degree of proximity of the target object and provided inside the hub 11 of the steering wheel 10 (steering operation unit) including the hub 11, the spoke 12, and the rim 13 (grip), the first proximity sensor being disposed along a lateral surface of the hub 11 connecting the first hub outer surface of the hub on a driver side and the second hub outer surface opposite the first hub outer surface, and, the electrostatic sensors 114A and 114B (second proximity sensors) each configured to output a second sensor value (difference value ΔAD) that varies according to a degree of proximity of the target object and provided inside the spoke, the electrostatic sensors 114A and 114B (second proximity sensors) being disposed along the lateral surface of the spoke 12 connecting the first spoke outer surface of the spoke 12 on the driver side and the second spoke outer surface opposite the first spoke outer surface, and the determination unit 131 configured to determine at least one of that the target object is in contact with the rim 13 (grip) when the second sensor value is regarded as a value greater than the first sensor value, or an amount of change in the second sensor value is regarded as a value greater than an amount of change in the first sensor value, and that the target object is not in contact with the rim 13 (grip) when the second sensor value is regarded as a value less than the first sensor value, or an amount of change in the second sensor value is regarded as a value less than an amount of change in the first sensor value. The operation of inserting a hand between the hub 11 and the left and right spokes 12 of the steering wheel 10 (steering operation unit) and the upper half portion of the rim 13 can be distinguished from the operation of touching the rim 13.

Therefore, it is possible to provide the sensor device 100 capable of detecting with high accuracy that the rim 13 (grip) of the steering wheel 10 (steering operation unit) is held.

The first proximity sensor may be the electrostatic sensor 111, the second proximity sensors may be the electrostatic sensors 114A and 114B, and the first sensor value and the second sensor value may be electrostatic capacitance values (difference values ΔAD). Therefore, the difference values ΔAD obtained from the electrostatic sensor 111 and the electrostatic sensors 114A and 114B can be used to more easily and reliably distinguish the operation of inserting a hand between the hub 11 and the left and right spokes 12 of the steering wheel 10 (steering operation unit) and the upper half portion of the rim 13 from the operation of touching the rim 13. Therefore, it is possible to provide the sensor device 100 capable of detecting with higher accuracy that the rim 13 (grip) of the steering wheel 10 (steering operation unit) is held.

The determination unit 131 is configured to determine that the second sensor value is regarded as a value greater than the first sensor value and the target object is in contact with the rim 13 (grip), when the first ratio R3 of the first sensor value to the second sensor value is less than a first predetermined threshold value or equal to or less than the first predetermined threshold value. The determination unit 131 is configured to determine that the second sensor value is regarded as a value less than the first sensor value and the target object is not in contact with the rim 13 (grip), when the first ratio R3 is more than the first predetermined threshold value or equal to or more than the first predetermined threshold value.

The sensor device 100 may further include the plurality of electrostatic sensors 112 (fourth proximity sensors) each configured to output a fourth sensor value (difference value ΔAD) that varies according to a degree of proximity of the target object, the electrostatic sensors 112 (fourth proximity sensors) being arranged, in a neutral state when the steering wheel 10 (steering operation unit) including the hub 11, the spoke 12, and the rim 13 (grip) is mounted on the vehicle, provided inside one of the hub 11 and the spoke 12 along the lateral surface connecting the first outer surface of the one of the hub 11 and the spoke 12 on the driver side and the second outer surface opposite the first outer surface, at a position closer to a floor of the vehicle relative to a center of the hub 11, and arranged from the hub 11 side toward the rim 13 (grip) side, wherein the determination unit is configured to determine that the target object is not in contact with the rim 13 (grip) when a third ratio R4, which is a ratio of a sensor value greater than the first sensor threshold value to a sensor value equal to or less than the first sensor threshold value among two sensor values, the first sensor threshold value being between the two sensor values, is less than a third predetermined threshold value, even when determining, based on the first sensor value and the second sensor value, that the target object is in contact with the rim 13 (grip), sequentially comparing, in an order from a sensor value of the electrostatic sensor 112 (fourth proximity sensor) on the rim 13 (grip) side toward a sensor value of the electrostatic sensor 112 (fourth proximity sensor) on the hub 11 side, each sensor value of the electrostatic sensors 112 (fourth proximity sensors) with a first sensor threshold value indicating that the target object is close to the rim 13 (grip), and determine that the target object is in contact with the rim 13 (grip) when the determination unit determines that the target object is in contact with the rim 13 (grip) based on the first sensor value and the second sensor value in conjunction with the third ratio R4 being equal to or greater than the third predetermined threshold value. Therefore, a state in which a hand is in contact with the rim 13 can be distinguished from a state in which a leg approaches the rim 13.

The sensor device 100 includes the plurality of electrostatic sensors 112 (proximity sensors) each configured to output a sensor value that varies according to a degree of proximity of the target object, the plurality of electrostatic sensors 112 (proximity sensors) being arranged, in a neutral state when the steering wheel 10 (steering operation unit) including the hub 11, the spoke 12, and the rim 13 (grip) is mounted on the vehicle, inside one of the hub 11 and the spoke 12 at a position closer to a floor of the vehicle relative to a center of the hub 11, and arranged from the hub 11 side toward the rim 13 (grip) side. The sensor device 100 is configured to determine, by comparing sensor values (difference values ΔAD) of the electrostatic sensors 112 (proximity sensors) and a first sensor threshold value TH124 indicating a leg or a hand (target object) is close to the rim 13 (grip), that the target object (hand) is not in contact with the rim 13 (grip) (including determination indicating that there is a probability that the target object is not in contact with the rim 13) when the electrostatic sensor 112 (proximity sensor) on the rim 13 (grip) side indicates a value equal to or greater than the first sensor threshold value TH124 and the electrostatic sensor 112 (proximity sensor) on the hub 11 side indicates a sensor value greater than the first sensor threshold value TH124 (S123: NO). The sensor device 100 is configured to determine that the hand (target object) is in contact with the rim 13 (grip) when the electrostatic sensor 112 (proximity sensor) on the hub 11 side indicates a value less than the second sensor threshold value TH126 (S128: NO).

The sensor device 100 may further include a determination unit 131 configured to determine that the leg is in contact with the rim 13 (grip) and the hand (target object) is not in contact with the rim 13 (grip) when a third ratio R4, which is a ratio of a sensor value greater than the first sensor threshold value TH124 (third sensor value) to a sensor value equal to or less than the first sensor threshold value TH124 (fourth sensor value) among two sensor values, the first sensor threshold value TH124 being between the two sensor values, is less than a third predetermined threshold value TH128 (S128: YES) because the sensor value of the hub side electrostatic sensor 112 (proximity sensor) is greater than a predetermined value, and determine that the target object is in contact with the rim 13 (grip) when the third ratio R4 is equal to or greater than the third predetermined threshold value TH128 (S128: NO) because the sensor value of the hub side electrostatic sensor 112 (proximity sensor) is less than a predetermined value. Therefore, it is possible to distinguish between a state in which a hand is in contact with the rim 13 and a state in which a leg approaches the rim 13.

Therefore, it is possible to provide the sensor device 100 capable of detecting with high accuracy that the rim 13 (grip) of the steering wheel 10 (steering operation unit) is held.

The determination unit 131 may determine that the target object is in contact with the rim 13 (grip), without comparing the third ratio R4 with the third predetermined threshold value, when, among the two sensor values, a sensor value that is equal to or less than the first sensor threshold value is equal to or less than a second sensor threshold value that is smaller than the first sensor threshold value. By using the third predetermined threshold value, it is possible to determine more easily and quickly that the object is in contact with the rim 13 (grip).

Further, although the sensor device of the exemplary embodiment of the present disclosure has been described above, the present invention is not limited to these embodiments, and various variations and modifications may be made without departing from the scope of the present invention.

What is claimed is:

1. A sensor device comprising:
a first proximity sensor configured to output a first sensor value that varies according to a degree of proximity of a target object and provided inside one of a hub or a spoke of a steering operation unit including the hub, the spoke, and a grip, the first proximity sensor being disposed along a first lateral portion of a lateral surface of the one of the hub or the spoke, the lateral surface connecting a first outer surface on a driver side and a second outer surface opposite the first outer surface, and the first lateral portion being located closer to the first outer surface than to the second outer surface;
a second proximity sensor configured to output a second sensor value that varies according to a degree of proximity of the target object and provided inside the one of the hub or the spoke, the second proximity sensor being disposed along a second lateral portion of the lateral surface, and the second lateral portion being located closer to the second outer surface than to the first outer surface; and
a processor configured to determine at least one of:
that the target object is in contact with the grip when:
the first sensor value and the second sensor value are equal to or greater than a threshold value and are values indicating that an arrangement of the target object relative to the first proximity sensor and an arrangement of the target object relative to the second proximity sensor are regarded as an equivalent positional relationship; or
an amount of change in the first sensor value and an amount of change in the second sensor value are equal to or greater than a threshold value and are values indicating that an arrangement of the target object relative to the first proximity sensor and an arrangement of the target object relative to the second proximity sensor are regarded as an equivalent positional relationship; or
that the target object is not in contact with the grip when:
the first sensor value and the second sensor value are values indicating that an arrangement of the target object relative to the first proximity sensor and an arrangement of the target object relative to the second proximity sensor are regarded as different positional relationships; or
an amount of change in the first sensor value and an amount of change in the second sensor value are values indicating that an arrangement of the target object relative to the first proximity sensor and an arrangement of the target object relative to the second proximity sensor are regarded as different positional relationships.

2. The sensor device according to claim 1, wherein:
the first proximity sensor and the second proximity sensor are electrostatic sensors; and
the first sensor value and the second sensor value are electrostatic capacitance values.

3. The sensor device according to claim 1, wherein when a first ratio between the first sensor value and the second sensor value is obtained, the processor is configured to determine at least one of:
that the first sensor value and the second sensor value are values indicating that an arrangement of the target object relative to the first proximity sensor and an arrangement of the target object relative to the second proximity sensor are regarded as an equivalent positional relationship and the target object is in contact with the grip, when the first ratio is within a predetermined range; or
that the values indicate that an arrangement of the target object relative to the first proximity sensor and an arrangement of the target object relative to the second proximity sensor are regarded as different positional relationships and the target object is not in contact with the grip, when the first ratio is not within the predetermined range.

4. The sensor device according to claim 3, further comprising a third proximity sensor configured to output a third sensor value that varies according to a degree of proximity of the target object and provided inside the one of the hub or the spoke, along the first outer surface or the second outer surface,
wherein the processor is configured to, in an event that the target object is determined to be in contact with the grip, determine that the target object is in contact with the grip when a second ratio of the third sensor value to a sum of the first sensor value and the second sensor value is less than a first predetermined threshold value, and determine that the target object is not in contact with the grip when the second ratio is equal to or greater than the first predetermined threshold value.

5. A sensor device comprising:
a first proximity sensor configured to output a first sensor value that varies according to a degree of proximity of a target object and provided inside one of a hub or a spoke of a steering operation unit including the hub, the spoke, and a grip, the first proximity sensor being disposed along a first outer surface on a driver side of the one of the hub or the spoke or a second outer surface opposite the first outer surface;
a second proximity sensor configured to output a second sensor value that varies according to a degree of proximity of the target object and provided inside the one of the hub or the spoke, the second proximity sensor being disposed along a lateral surface connecting the first outer surface and the second outer surface; and
a processor configured to determine at least one of:
that the target object is in contact with the grip when:
the second sensor value is regarded as a value greater than the first sensor value; or
an amount of change in the second sensor value is regarded as a value greater than an amount of change in the first sensor; or
that the target object is not in contact with the grip when:
the second sensor value is regarded as a value less than the first sensor value; or
an amount of change in the second sensor value is regarded as a value less than an amount of change in the first sensor.

6. The sensor device according to claim 5, wherein:
the first proximity sensor and the second proximity sensor are electrostatic sensors; and
the first sensor value and the second sensor value are electrostatic capacitance values.

7. The sensor device according to claim 5, wherein when a first ratio of the first sensor value to the second sensor value is obtained, the processor is configured to determine at least one of:
that the second sensor value is regarded as a value greater than the first sensor value and the target object is in contact with the grip when the first ratio is less than a first predetermined threshold value or equal to or less than the first predetermined threshold value; or
that the second sensor value is regarded as a value less than the first sensor value and the target object is not in contact with the grip when the first ratio is more than the first predetermined threshold value or equal to or more than the first predetermined threshold value.

8. The sensor device according to claim 7, further comprising a third proximity sensor configured to output a third sensor value that varies according to a degree of proximity of the target object and provided inside the hub, along a hub lateral surface connecting a first hub outer surface of the hub on the driver side and a second hub outer surface opposite the first hub outer surface, wherein:
the second proximity sensor is provided inside the spoke, along a spoke lateral surface connecting a first spoke outer surface of the spoke on the driver side and a second spoke outer surface opposite the first spoke outer surface;
the third proximity sensor is provided adjacent to the second proximity sensor; and
the processor is configured to, in an event that the target object is determined to be in contact with the grip, determine that the target object is in contact with the grip when a second ratio of the third sensor value to the second sensor value is less than a second predetermined threshold value, and determine that the target object is not in contact with the grip when the second ratio is equal to or greater than the second predetermined threshold value.

9. A sensor device comprising:
a first proximity sensor configured to output a first sensor value that varies according to a degree of proximity of a target object and provided inside a hub of a steering operation unit including the hub, a spoke, and a grip, the first proximity sensor being disposed along a lateral surface of the hub connecting a first hub outer surface of the hub on a driver side and a second hub outer surface opposite the first hub outer surface, and;
a second proximity sensor configured to output a second sensor value that varies according to a degree of proximity of the target object and provided inside the spoke, the second proximity sensor being disposed along a lateral surface of the spoke connecting a first spoke outer surface of the spoke on the driver side and a second spoke outer surface opposite the first spoke outer surface; and
a processor configured to determine at least one of:
that the target object is in contact with the grip when:
the second sensor value is regarded as a value greater than the first sensor value; or
an amount of change in the second sensor value is regarded as a value greater than an amount of change in the first sensor value; or
that the target object is not in contact with the grip when:
the second sensor value is regarded as a value less than the first sensor value; or
an amount of change in the second sensor value is regarded as a value less than an amount of change in the first sensor value.

10. The sensor device according to claim 9, wherein:
the first proximity sensor and the second proximity sensor are electrostatic sensors; and
the first sensor value and the second sensor value are electrostatic capacitance values.

11. The sensor device according to claim 9, wherein the processor is configured to determine at least one of:
that the second sensor value is regarded as a value greater than the first sensor value and the target object is in contact with the grip, when a first ratio of the first sensor value to the second sensor value is less than a first predetermined threshold value or equal to or less than the first predetermined threshold value; or
that the second sensor value is regarded as a value less than the first sensor value and the target object is not in contact with the grip, when the first ratio is more than the first predetermined threshold value or equal to or more than the first predetermined threshold value.

12. The sensor device according to claim 1, further comprising a plurality of fourth proximity sensors each configured to output a fourth sensor value that varies according to a degree of proximity of the target object, the fourth proximity sensors being arranged, in a neutral state when the steering operation unit including the hub, the spoke, and the grip is mounted on a vehicle, provided inside one of the hub or the spoke along the lateral surface connecting the first outer surface of the one of the hub or the spoke on the driver side and the second outer surface opposite the first outer surface, at a position closer to a floor of the vehicle relative to a center of the hub, and arranged from a hub side toward a grip side,
wherein the processor is configured to:
determine that the target object is not in contact with the grip when a third ratio, which is a ratio of a sensor value greater than the first sensor threshold value to a sensor value equal to or less than the first sensor threshold value among two sensor values, the first sensor threshold value being between the two sensor values, is less than a third predetermined threshold value, even when determining, based on the first sensor value and the second sensor value, that the target object is in contact with the grip, sequentially comparing, in an order from a sensor value of a fourth proximity sensor on the grip side toward a sensor value of a fourth proximity sensor on the hub side, each sensor value of the fourth proximity sensors with a first sensor threshold value indicating that the target object is close to the grip; and
determine that the target object is in contact with the grip when the processor determines that the target object is in contact with the grip based on the first sensor value and the second sensor value in conjunction with the third ratio being equal to or greater than the third predetermined threshold value.

13. A sensor device comprising:
a plurality of proximity sensors each configured to output a sensor value that varies according to a degree of proximity of a target object, the plurality of proximity sensors being arranged, in a neutral state when a steering operation unit including a hub, a spoke, and a grip is mounted on a vehicle, inside one of the hub or the spoke at a position closer to a floor of the vehicle relative to a center of the hub, and arranged from a hub side toward a grip side; and
a processor configured to determine, by comparing sensor values of the proximity sensors and a first sensor threshold value indicating the target object is close to the grip, at least one of:
that the target object is not in contact with the grip when a proximity sensor on the grip side indicates a value equal to or greater than the first sensor threshold value and a proximity sensor on the hub side indicates a sensor value greater than the first sensor threshold value; or
that the target object is in contact with the grip when the proximity sensor on the grip side indicates a value equal to or greater than the first sensor threshold value and the proximity sensor on the hub side indicates a value less than a second sensor threshold value, the second sensor value being a value equal to or less than the first sensor threshold value.

14. The sensor device according to claim 13, comprising the processor configured to determine:
that the target object is not in contact with the grip when a third ratio, which is a ratio of a sensor value greater than the first sensor threshold value to a sensor value equal to or less than the first sensor threshold value among two sensor values, the first sensor threshold value being between the two sensor values, is less than a third predetermined threshold value; and
that the target object is in contact with the grip when the third ratio is equal to or greater than the third predetermined threshold value.

15. The sensor device according to claim 14, wherein the processor is configured to determine that the target object is in contact with the grip, without comparing the third ratio with the third predetermined threshold value, when, among the two sensor values, a sensor value that is equal to or less than the first sensor threshold value is equal to or less than the second sensor threshold value that is smaller than the first sensor threshold value.
